(19) United States
(12) Patent Application Publication
(10) Pub. No.: US 2012/0121944 A1
(43) Pub. Date: May 17, 2012

(54) BATTERY PACK, METHOD OF MANUFACTURING BATTERY PACK, AND MOLD FOR MANUFACTURING BATTERY PACK

(76) Inventors: Takeru YAMAMOTO, Fukushima (JP); Sachio Akahira, Fukushima (JP); Masahiro Sawaguchi, Fukushima (JP)

(21) Appl. No.: 13/275,475

(22) Filed: Oct. 18, 2011

(30) Foreign Application Priority Data
Nov. 12, 2010 (JP) P2010-254277
Jan. 19, 2011 (JP) P2011-008520

(51) Int. Cl. H01M 2/02; B29C 45/14; H01M 2/00

(52) U.S. Cl. 429/7; 429/176; 264/272.15; 425/542

(57) ABSTRACT

A battery pack includes a formed portion coating at least a portion of the outer surface of a battery or a plurality of battery packs with reaction-curable resin; and spacers having dimension-absorbing ability and attached to the rear surface of the formed portion.

### BACKGROUND

The present disclosure relates to a battery pack accommodating non-aqueous electrolyte secondary battery pack, a method of manufacturing a battery pack, and a mold for manufacturing a battery pack.

Recently, many portable electronic apparatuses, such as a camera-integrated VTR (videotape recorder), a mobile phone, or a laptop computer, have been introduced to market, and downsizing and weight-saving have been researched. Accordingly, the demand for batteries used as power sources of the portable electronic apparatuses has increased rapidly, and in order to implement downsizing and weight-saving in the devices, it is necessary to design a light and thin battery and efficiently use the accommodating space in the devices. Lithium ion secondary batteries having large energy density and output density are the most suitable as the battery satisfying these requirements.

Lithium ion secondary batteries are equipped with a battery element, which has a positive electrode and a negative electrode allowing lithium ions to be doped/undoped and is enclosed in a metal can or a metal-laminate film, and are controlled by a circuit board that is electrically connected with the battery element.

In the lithium ion secondary batteries, a lithium ion polymer secondary battery that uses a gel state polymer electrolyte is commonly used to prevent leakage of electrolyte solution, which is a problem when using liquid-based electrolysis solution of the related art. In the lithium ion polymer secondary battery, the battery element is manufactured by connecting electrode terminals each other, stacking a positive electrode and a negative electrode, which are formed in a band shape by applying polymer electrolyte onto both sides, through a separator, and longitudinally winding the electrodes. Further, a battery pack is achieved by packing the battery element with a laminate film into a battery cell and accommodating the battery cell in a resin-molded case.

As described in Japanese Patent Unexamined Application Publication No. 2008-140757, a battery pack that does not use an exterior case as a battery pack that can greatly simplify the assembly process has been proposed. That is, the battery pack is manufactured by implementing a battery component by connecting a circuit board to a battery, temporarily holding the battery component in the molding chamber of a resin-molding mold, and injecting solution-state synthetic resin into the molding chamber. The resin molding portion can integrally fix the circuit board, the connected terminals, or the battery while forming an exterior case of the battery pack.

### SUMMARY

The battery element has a relatively large tolerance with respect to the regulated dimension. The reason is because spring back of the electrodes accompanying the first charging after pressing the particles of an electrode active material having high tap density at high pressure is amplified as much as the number of stacking. Further, even if alloybased electrode active materials are manufactured by a gas phase method, such as deposition, the change in volume of the alloy is large in charging/discharging and a plurality of electrode layers are stacked, such that a large dimensional tolerance is provided.

In the related art, since the battery element is received in a formed product made of thermoplastic resin or an exterior package having a predetermined dimension, such as a metal can made of iron or aluminum, the large dimensional tolerance of the battery element is not reflected in the outer diameter of the pack.

Meanwhile, using an exterior package having predetermined dimensions has a demerit in that a space is defined between the exterior package and the battery element due to the dimensional tolerance and a change in thickness is large due to the generation of a gas at a high temperature and the charging/discharging cycle. Further, when the footprint of the battery is 24 cm² or more (for example, 4 cm×6 cm or 3 cm×8 cm), deep-drawing of metal is difficult and the number of molds for deep drawing increases.

As a result, there is a problem in that the exterior package increases in thickness, the energy density reduces, and the cost increases. Even for a molded product made of thermoplastic resin, when the footprint of the battery is 24 cm² or more, there is a problem in that a thickness of 250 μm to 300 μm or more is necessary due to a limit in the fluidity of resin.

When the battery element is formed by directly molding resin, it is possible to avoid the problem when using an exterior package having predetermined dimensions. On the contrary, the dimensional tolerance of the battery element is not absorbed by the exterior package while a battery or a plurality of batteries in which a battery element having a large dimensional tolerance is packed by a film-packing body are directly formed by reaction-curable resin. When the electrode layers opposite to the positive/negative interface are fourteen layers in the battery element, the dimensional tolerance of the directly formed battery becomes to large to ignore.

Therefore, it is necessary to reduce the yield ratio of the battery element or provide sufficient room for the designed thickness for the forming resin, in order to limit the dimensional tolerance of the battery. These measures have a problem of causing the increases in cost and decreasing the energy density. This situation is further intensified, when a plurality of batteries is collectively and directly formed.

When a battery pack in which the battery or a group of the batteries described above is manufactured by directly forming reaction-curable resin, the viscosity is preferably 80 mPa to less than 1000 mPa, such that the fluidity is excellent and the forming is possible with a thickness of 250 μm even if the footprint is 24 cm² or more (for example, 4 cm×6 cm or 3 cm×8 cm). However, the larger the footprint and the more the number of batteries increases, the more the number of channels having different forming resin thicknesses increases in the battery pack, such that a defect in forming, such as charging defects or bubble biting, increases. Increasing the forming yield ratio by allowing an unnecessarily excessive amount of resin to flow may be considered as a measure. However, this method decreases productivity and the cost of the raw material may increase.

Therefore, it is desirable to provide a battery pack that makes it possible to manufacture an external packaging part by forming resin, without a severe limit in dimensional tolerance of a battery element, a method of manufacturing a battery pack, and a mold for manufacturing the battery pack.

A battery pack according to an embodiment of the present disclosure includes: a formed portion coating at least a portion of the outer surface of a battery or a plurality of batteries with reaction-curable resin; and spacers having dimension-absorbing ability and attached to the rear surface of the formed portion.

A battery pack according to another embodiment of the present disclosure includes a formed portion in which at least of the sides of a battery or a plurality of batteries are directly formed; and a protection circuit, in which at least the thickest portion of the battery is exposed from the formed portion.

A method of manufacturing a batter pack according to another embodiment of the present disclosure includes positioning a battery or a plurality of batteries in a forming space by using a mold protrusion having dimension-absorbing ability and forming a formed portion by filling the forming space with reaction-curable resin less than 120° C.

A mold for manufacturing a battery pack according to another embodiment of the present disclosure includes a mold protrusion that protrudes from the inner surface of a mold having a forming space accommodating a battery or a plurality of battery packs and filled with reaction-curable resin, has a convex shape being in contact with the surface of the battery, has the area at the inner surface of the mold larger than the area at the contact portion with the surface of the battery, and has a substantially conical shape or a pyramid shape.

According to the present disclosure, there are provided a battery pack that can accurately position a battery component at a predetermined position in a cavity in a mold even if there is a change in dimensions of a battery, a method of manufacturing a battery pack, and a mold for manufacturing a battery pack.

### BRIEF DESCRIPTION OF THE DRAWINGS

FIG. 1 is a perspective view showing the external appearance of a battery pack.

FIG. 2 is a schematic diagram that is used to describe a coating process of an exterior film of a battery element.

FIG. 3 is a perspective view that is used to describe the battery element.

FIGS. 4A to 4D are schematic diagrams that are used to describe resin molding of a battery component.

FIGS. 5A to 5E are schematic diagrams that are used to describe a plurality of examples of a spacer.

FIGS. 6A to 6L are schematic diagrams that are used to describe a plurality of examples of a spacer.

FIGS. 7A to 7F are schematic diagrams that are used to describe a plurality of examples of a spacer.

FIGS. 8A and 8B are schematic diagrams that are used to describe a plurality of examples of a spacer.

FIGS. 9A to 9C are schematic diagrams that are used to describe the function of the spacer.

FIGS. 10A and 10B are perspective views that are used to describe the function of the spacer.

FIGS. 11A to 11D are schematic diagrams that are used to describe resin molding of a battery component.

FIG. 12 is a perspective view showing the external appearance of a battery pack.

FIGS. 13A and 13B are schematic diagrams that are used to describe an example of a battery pack having positioning marks.

FIGS. 14A to 14C are schematic diagrams that are used to describe an example of a mold and a battery pack having positioning marks.

FIGS. 15A and 15B are schematic diagrams that are used to describe an example of a battery pack having positioning marks.

FIGS. 16A and 16B are schematic diagrams that are used to describe an example of a battery pack having positioning marks.

FIGS. 17A and 17B are schematic diagrams that are used to describe an example of a battery pack having positioning marks.

FIGS. 18A and 18B are schematic diagrams that are used to describe an example of a battery pack having positioning marks.

FIGS. 19A to 19D are schematic diagrams that are used to describe an example of a battery pack having positioning marks.

FIGS. 20A to 20C are schematic diagrams that are used to describe an example of a battery pack having both positioning marks and a spacer.

FIGS. 21A to 21D are schematic diagrams that are used to describe in-mold forming.

FIG. 22 is a schematic diagram that is used to describe flow of resin in molding when a spacer is provided.

FIGS. 23A to 23c are a perspective view and a plan view of an example of a battery pack having a frame-shaped formed part.

FIGS. 24A and 24B are plan views of an example of a battery pack having the frame-shaped formed part and provided with a spacer.

FIGS. 25A and 25B are plan views of another example of a battery pack having a frame-shaped formed part.

FIGS. 26A to 26C are schematic diagrams that are used to process a sealed portion of a laminate film.

FIGS. 27A to 27D are schematic diagrams that are used to describe a battery pack formed to cover the end of the sealed portion.

FIGS. 28A to 28D are schematic diagrams that are used to describe a battery pack formed to cover the end of the sealed portion.

FIGS. 29A and 29B are schematic diagrams that are used to describe a battery pack formed to cover the end of the sealed portion and having a fitting slit.

FIGS. 30A to 30C are schematic diagrams that are used to describe a battery pack having a fitting portion or a connecting portion in the formed part.

FIGS. 31A to 31D are schematic diagrams that are used to describe connection between a circuit board of a battery pack with the outside.

### DETAILED DESCRIPTION OF EMBODIMENTS

Hereinafter, embodiments of the present disclosure are described. Further, the embodiments described below are detailed examples that are suitable to the present disclosure, and are given various technologically preferable limits, the aspect of the present disclosure is not limited to the embodiments in the following description, unless it is stated that the embodiments limit the present disclosure.

### Example of Battery Pack

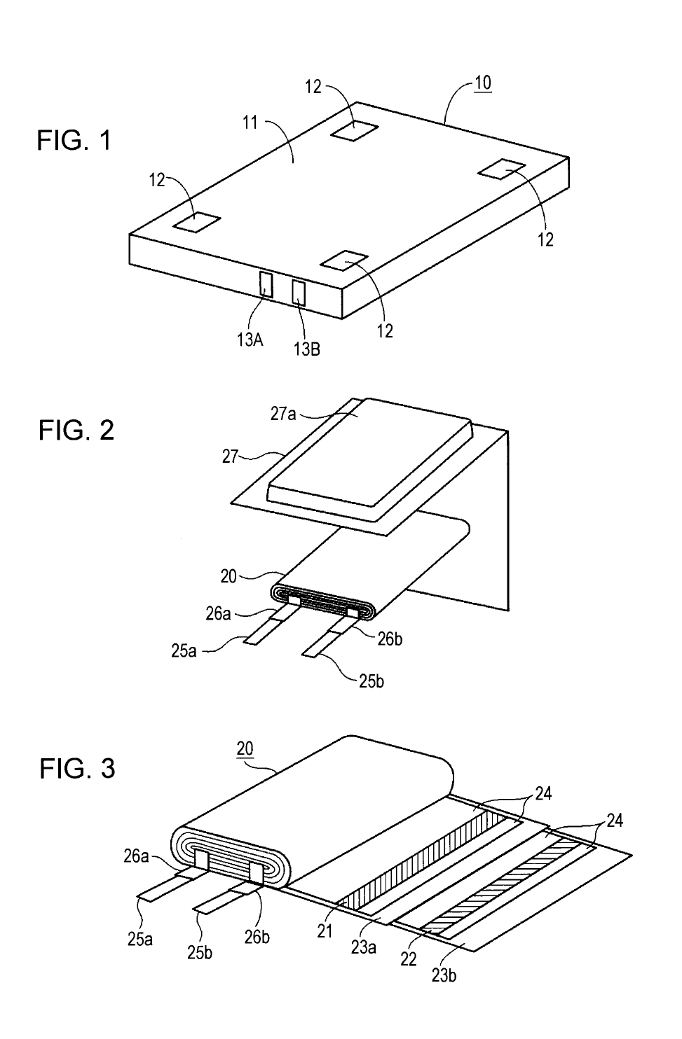

As shown in FIG. 1, a battery pack 10 has a flat rectangular external appearance and is coated with a formed part (exterior package 11) in which a battery and a protection circuit board of the battery are integrally made of reaction-curable resin. A plurality of small spacers 12 is attached to the main surfaces (the top and the bottom) of the formed part 11 of the battery pack 10. The spacers 12 have ability of absorbing a dimensional change of the battery. The ability is referred to as a dimension-absorbing ability in the following adscription. In the example of FIG. 1, rectangular spacers 12 are attached around the four corners on the main surfaces. The shapes and the attachment positions of the spacers 12 can be changed in various ways, other than that shown in FIG. 1, as described below.

The dimension-absorbing ability of the spacer 12 is ability that can dispose the battery at the center position of the forming space (cavity) with high accuracy, even if there is a difference in the regulated dimensions in the battery in forming. That is, the spacer 12 is, for example, made of fabric having holes therein, and even if the dimensions of the battery change, the spacer changes, for example, in thickness in accordance with the change in dimensions, such that it can maintain the battery at a predetermined position in the cavity. A resin charging space is maintained while the resin flows to every nook and corner in the cavity covering the maximum surface, due to the spacers 12.

Openings 13A and 13B are formed at the end of the front of the formed part 11, the positive electrode and the negative electrode of the battery inside are exposed through the openings 13A and 13B, and, for example, an external connection electrode is connected to the electrodes inside through the openings 13A and 13B, such that the battery can be charged/discharged. Further, as described below, an element achieved by winding or stacking the positive electrode and the negative electrode through a separator is referred to as a battery element, a configuration achieved by coating the battery element with a laminate film is referred to as a battery, and a configuration in which a battery and a circuit substrate are made of resin is referred to as the battery pack 10.

As described above, the substrate and the battery are integrally fixed by the resin. However, the positional relationship between the substrate and the battery can be changed in various ways. For example, the directly formed battery and the substrate portion may be separately formed, and the battery and the substrate portion may be fitted and welded.

The substrate terminal may be formed in various shapes, and a type in which the terminal is formed in a plane shape and contact with a pin of a device and charging/discharging is performed is preferable because it is easy to determined a range where forming resin flows inside and a range where forming resin fails to flow inside due to the flatness of the surface. It is possible to improve productivity by disposing a resin drift that passes excessive resin at the front of the terminal even in a tabby shape in which the terminal and the pin of a device are fitted.

Further, it is preferable to implement a type of leading a connector from a substrate and fitting it to a device. The terminal portion is necessary to be conductive, which is expensive, the resin coated on the substrate or the battery preferably has high insulation and high fluidity, which is because the conductive portion may be coated. The battery pack implemented by leading a connector from substrate is formed by pressing the lead portion of the battery pack with a close-contacting material, such as rubber, such that it is possible to simply prevent insulating resin from flowing into the conductive portion of the connector; therefore, it is possible to improve productivity and provide a battery pack at a low cost.

Other than the protection circuit including a temperature protection element, such as a fuse, a PTC (Positive Temperature Coefficient) element, and a thermistor, an ID resistor for identifying the battery pack is mounted on the circuit board, and contact portions are further formed (for example, two or three). A charging/discharging control FET (Field Effect Transistor) and an IC (Integrated Circuit) performing control of a secondary battery monitoring and charging/discharging control FET are disposed on the protection circuit.

The PCT element is connected in series with the battery element, and when the temperature of the battery increases more than a set temperature, the electric resistance rapidly increases and the current flowing in the battery is substantially blocked. The fuse is also connected in series with the battery element, such that when overcurrent flows in the battery, the fuse is melted and blocks the current. Further, a heater resistor is disposed around the fuse and the temperature of the heater resistor increases and is melted when overvoltage is applied, thereby blocking the current.

Further, if the terminal voltage of the secondary battery exceeds 4.3V to 4.4V, a dangerous state may occur, such as heat generation or fire, may occur. Therefore, the protection circuit monitors the voltage of the secondary battery and prevents charging by turning off the charging control FET, in an overcharging state with the voltage above 4.3V to 4.4V. Further, when the terminal voltage of the secondary battery is overdischarged to a charging-preventing voltage or less and the voltage of the secondary battery becomes 0V, the secondary battery becomes in an internal short state, such that recharging may not be performed. Therefore, when the overdischarging state is caused, resulting from monitoring the voltage of the secondary battery, the discharging control FET is turned off and discharging is prevented.

An example of the battery is described. The battery is implemented, as shown in FIGS. 2 and 3, by packaging the battery element 20, which is achieved by winding or stacking a positive electrode 21 and a negative electrode through separators 23a and 23b, with a laminate film 27, which is a package. As shown in FIG. 2, the battery element 20 is accommodated in a rectangular recess 27a formed on the laminate film 27 and the edge (three sides except for a curved portion) is bonded and sealed by heat. The portion where the laminate film 27 is bonded is a terrace portion. The terrace portions at both sides of the recess 27a bend toward the recess 27a.

Further, as the laminate film 27 that is a package, a metal laminate film that is used in the related art, for example, an aluminum laminate film may be used. It is preferable that the aluminum laminate film is suitable for drawing and appropriate to form the recess 27a accommodating the battery element 20.

In general, the aluminum laminate film has a stacking structure with a bonding layer and a surface protection layer on both sides of an aluminum layer, in which a polypropylene layer (PP layer) that is the bonding layer, an aluminum layer that is a metal layer, and a nylon layer or a polyethylene terephthalate layer (PET layer) that is the surface protection layer are sequentially disposed from the inside, that is, the surface of the battery element 20.

Further, the laminate film 27 that is a package is a single layer or two-layered film, other than the aluminum laminate film and may include a polyolefin film. The thickness of the laminate film is, for example, 0.2 mm or less.

As shown in FIG. 3, the band-shaped positive electrode 21, the separator 23a, the band-shaped negative electrode 22 disposed opposite to the positive electrode 21, and the separator 23b are sequentially stacked and the stacked body is longitudinally wound. A gel-state electrolyte 24 is applied on both sides of the positive electrode 21 and the negative electrode 22. A positive lead 25a connected with the positive electrode 21 and a negative lead 25b connected with the negative electrode 22 are led from the battery element 20. Sealants 26a and 26b that are resin members, such as maleic acid anhydride-denatured polypropylene (PPa), are coated on the positive lead 25a and the negative lead 25b to increase an adherence property with the laminate film, which is enclosed later.

The components of the battery are described in detail. The present disclosure can be applied to batteries, other than the battery described below. For example, the electrolyte is not limited to the gel state and a liquid-state or solid-state electrolyte may be used. Further, the present disclosure may be applied to a battery implemented not by winding the band-shaped positive electrode, the separators, and the negative electrode, but by stacking these plate-shaped components.

### (Positive Electrode)

The positive electrode 21 is implemented by forming a positive electrode active material layer including a positive electrode active material on both sides of a positive electrode power collector. As the positive electrode power collector, a metal sheet, such as an aluminum (Al) sheet, a nickel (Ni) sheet, or a stainless steel (SUS) sheet, is used.

The positive electrode active material layer contains, for example, a positive electrode active material, a conductive agent, and a binding agent. As the positive electrode active material, a complex oxide of lithium and transition metal, which contains LiₓMO₂ (where M is one or more kinds of transition metal, x is usually 0.05 or more to 1.10 or less, depending on the charging/discharging state of the battery) as a main component, is used. As the transition metal of the lithium complex oxide, cobalt (Co), nickel (Ni), and manganese (Mn) are used.

As the lithium complex oxide, in detail, cobalt acid lithium (LiCoO₂), nickel acid lithium (LiNiO₂), and manganese acid lithium (LiMn₂O₄) may be considered. Further, a solid solution with some of the transition metal element replaced with other elements may be used. For example, a nickel cobalt complex lithium oxide (LiNi_{0.5}Co_{0.5}O₂, LiNi_{0.8}Co_{0.2}O₂ or the like) may be used. Further, the lithium complex oxide can generate high pressure, such that energy density is excellent. Further, as the positive electrode active material, a metal sulfide or a metallic oxide without lithium, such as TiS₂, MoS₂, NbSe₂, and V₂O₅, may be used. A complex mixture of the materials is used as the positive electrode active material.

Further, as the conductive agent, a carbon material, such as carbon black or graphite, may be used. Further, as the binding agent, for example, polyvinylindene fluoride (PVdF) or polytetrafluoroethylene (PTFE) is used. Further, as a solvent, for example, N-methyl-2-pyrolidone (NMP) is used.

### (Negative Electrode)

The negative electrode 22 is implemented by forming a negative electrode active material layer including a negative electrode active material on both sides of a negative electrode power collector. As the negative electrode power collector, a metal sheet, such as a copper (Cu) sheet, a nickel (Ni) sheet, or a stainless steel (SUS) sheet, is used.

The negative electrode active material layer contains, for example, a negative electrode active material, a conductive agent, and a binding agent. As the negative electrode active material, lithium metal, a lithium alloy, or a carbon material that can be doped/undoped with lithium, or a compound of a metallic material and a carbon-based material are used. In detail, as the carbon material that can be doped/undoped with lithium, graphite, non-graphitizable carbon, and graphitizable carbon may be considered, and in more detail, a carbon material, such as a pyrolytic carbon-based material, a coke-based material (pitch coke, needle coke, petroleum coke), a graphite-based material, a glassy carbon-based material, an organic high-molecular compound burned substance (carbonated material by burning phenol resin and fran resin at an appropriate temperature), carbon fiber, and activated carbon, may be used. Further, the material that can be doped/undoped with lithium, a high molecular material, such as polyacetylene and polypyrrole, or a LₓTi_{y}O_{z}-based oxide, such as SnO₂ and Li₄Ti₅O₁₂, may be used.

Further, as a material that can alloy lithium, although various kinds of metals are used, stannum (Sn), cobalt (Co), indium (In), aluminum (Al), silicon (Si), and their alloys are commonly used. When lithium metal is used, it is not necessary to implement an applied film of powder body binding agent, and it may be possible to use a rolled lithium metal sheet.

Further, as the binding agent, for example, polyvinylindene fluoride (PVdF) or styrene-butadiene rubber (SBR) may be used. Further, as a solvent, for example, N-methyl-2-pyrolidone (NMP), methyl ethyl ketone (MEK), and distilled water may be used.

### (Electrolyte)

Electrolyte salt and non-aqueous solvent that are generally used for the lithium secondary battery may be used for the electrolyte. As the non-aqueous solvent, in detail, ethylene carbonate (EC), propylene carbonate (PC), y-butyrolactone, dimethylcarbonate (DMC), diethylcarbonate (DEC), ethylmethylcarbonate (EMC), dipropylcarbonate (DPC), ethyldipropylcarbonate (EPC), or a solvent with the carbonate ester-based hydrogen replaced with halogen, may be considered. One kind may be used or a mixture of a plurality of kinds may be used for the solvent.

The electrolyte salt is dissolved in a non-aqueous solvent and the cations and the anions are bonded. Alkali metal or alkaline-earth metal is used for the cations. Cl⁻, Br⁻, I⁻, SCN⁻, CIO₄, BF₄⁻, PF₆⁻, CF₃SO₃⁻, or the like is used. In detail, lithium hexafluorophosphate (LiPF₆), lithium tetrafluorophosphate (LiBF₄), bis(trifluoromethanesulfonyl) imidelithium (LiN(CF₃SO₂)₂), bis(pentafluoroethanesulfonyl) imidelithium (LiN(C₂F₅SO₂)₂), and perchloric acid (LiClO₄) may be considered. The concentration of the electrolyte may be concentration where it can be dissolved in a solvent, but it is preferable that the lithium ion concentration is within a range of 0.4 mol/kg or more to 2.0 mol/kg or less for a non-aqueous solvent.

When a polymer electrolyte is used, the polymer electrolyte is achieved by putting the electrolytic solution made in a gel state by mixing a non-aqueous solvent with a electrolyte solvent into matrix-polymer. The matrix-polymer has compatibility with the non-aqueous solvent. As the matrix-polymer, silicon gel, acryl gel, acrylonitrile gel, polyphosphazene-denatured polymer, polyethylene oxide, polypropylene oxide, and complex polymers, cross-linked polymers, and denatured polymers may be considered. Further, as the fluorine-based polymer, a polymer, such as polyvinylidene fluoride (PVdF), copolymer containing vinylidene fluoride (VdF) and hexafluoropropylene (HFP) in a repeating unit, and copolymer containing vinylidene fluoride (VdF) and trifluoroethylene (TFE), may be selected. One kind may be used or two or more kinds of the polymers may be mixed and used.

It is preferable that the electrolyte in the polymer contains a metallic oxide and a complex oxide, which contain any one of Si, Al, Ti, Zr, and W. This is because it is possible to expect an effect of restraining expansion at a high temperature while increasing safety and reliability by ensuring insulation in an abnormal state.

### (Separator)

The separators 23a and 23b are implemented by a porous film made of a polyolefin-based material, such as polypropylene (PP) or polyethylene (PE) or a porous film made of an inorganic material, such as ceramic fabric, and may have a structure in which these two or more kinds of porous films are stacked. In those films, the polyethylene and polypropylene porous films are the most useful.

In general, the thickness of a separator is very appropriate at 5 μm or more to 50 μm or less, but is preferably 7 μm or more to 30 μm or less. When the separators are too thick, the charging amount of the active material decreases and the battery capacity decreases while the ion conductivity decreases, such that current characteristic is deteriorated. On the contrary, when they are too thin, the mechanical properties of the films are deteriorated.

### [Resin Forming Apparatus]

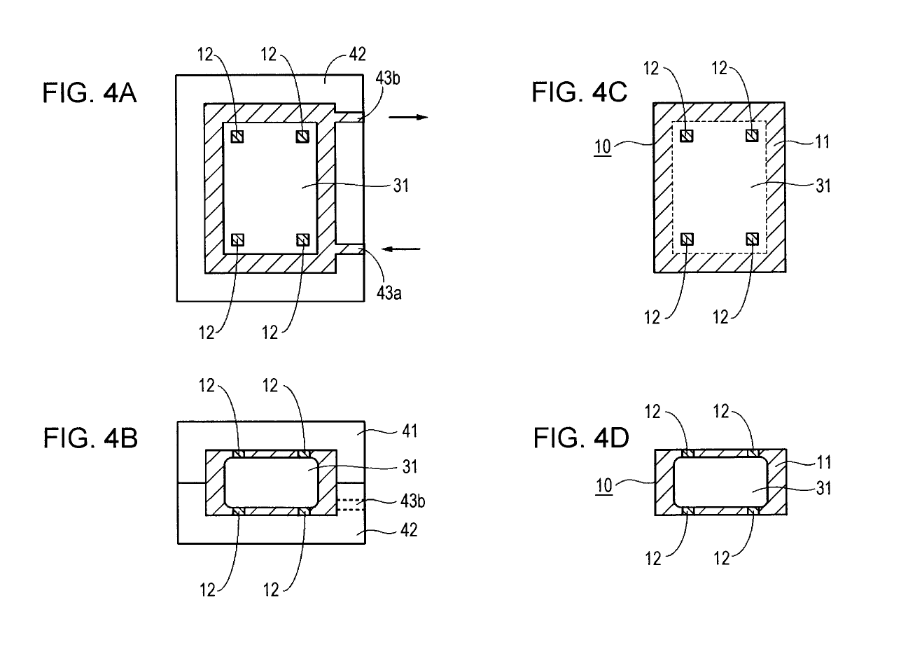

Forming of the formed part 11 of the battery pack is described with reference to FIG. 4. The battery component 31 schematically showing both of the battery and the circuit board is accommodated in the cavity (forming space) of the mold of a forming apparatus. Further, a plurality of batteries and circuit boards may be resin-formed. The four spacers 12 are attached around the four corners in advance, on the main surfaces of the battery component. The mold is composed of an upper mold 41 and a lower mold 42 and the bonding surface of the upper mold 41 and the lower mold 42 is a flat surface.

For example, two gate holes 43a and 43b are formed at the lower mold 42. The gate hole 43a is a channel through which resin flows inside in forming and the gate hole 43b is a channel through which the resin is discharged in forming. The upper mold 41 and the lower mold 42 are made of metal, plastic, or ceramic.

As shown in FIGS. 4A and 4B, the cavity for forming is defined by both of the upper mold 41 and the lower mold 42 and the battery component 31 with the spacer 12 attached is accommodated in the cavity. Resin that becomes the formed part 11 is injected into the cavity from the gate hole 43a and discharged from the gate hole 43b. As shown in FIGS. 4C and 4D, after the resin is hardened, the upper mold 41 and the lower mold 42 are separated and the battery pack 10 with the battery component 31 coated with the formed part 11 is formed. Further, in FIG. 4, the spacers 12 and the resin are indicated by hatched lines.

Further, the upper mold 41 and the lower mold 42 that are used have two or more gates for introducing the molten forming material into the cavity. Therefore, in the achieved battery pack, the excessive forming material corresponding to the gates remain and harden at anywhere of the external packaging material, such that the excessive forming material is removed by trimming in the present disclosure.

Further, when reaction-curable resin is filled in the cavity, it is necessary to fill the cavity while applying pressure of a common external packaging material in order to prevent a gap from being generated in the cavity. Therefore, various measures may be considered to restrain the battery component 31 from being moved from a predetermined position by the reaction-curable resin that is filled under a pressure in the cavity. For example, it may be possible to separately inject the reaction-curable resin two times or more such that the battery component 31 is maintained at a predetermined position by the portions where the resin is not injected, while the reaction-curable resin flows to every nook and corner. For example, a positioning part formed by winding an integral tape, rubber member, or mesh-shaped part one around a cell may be used.

Depending on the resin composition of the reaction-curable resin, heat generation in hardening and hardening contraction from mixing of two kinds of liquid from hardening may increase. In order to restrain the heat generation in hardening, it is preferable to discharge low molecular resin having sufficiently low viscosity as the resin raw material at a lower temperature of 55° C. or less and to use aluminum or SUS which has sufficiently large capacity and high thermal conductivity for the upper mold 41 and the lower mold 42. For the hardening contraction, a structure of discharging a sufficiently larger amount of resin than the necessary amount of resin by providing a resin drift in the mold and then supplying the resin raw material accompanying the hardening contraction to the resin drift.

Since the spacers 12 described above has the dimension-absorbing ability, it is possible to firmly hold the battery component 31 at the predetermined position in the cavity of the mold, even if the dimensions of the battery component 31 (particularly, a battery with the battery element coated with a laminate film) are not uniform.

### (Resin of Formed Part)

The formed part 11 is made of reaction-curable resin, such as thermosetting resin that is hardened by reacting with heat and ultraviolet-curable resin that is hardened by reacting with ultraviolet rays. The formed part 11 is a resin-formed material that is formed when reaction-curable resin is hardened.

### (Reaction-Curable Resin)

As the reaction-curable resin, at least one selected from urethane resin, epoxy resin, acryl resin, silicon resin, and dicyclopentadiene resin may be considered. In the resin, at least one selected from the urethane resin, epoxy resin, acryl resin, and silicon resin is preferable.

### (Urethane Resin)

The urethane resin is made of polyol and polyisocyanate. It is preferable to use the insulating polyurethane resin defined below as the urethane resin. The insulating polyurethane resin means a substance from which a hardened material having a volume eigen value (Ω·cm) of 10¹⁰ Ω·cm, which is measured at 25±5° C., 65±5% RH. It is preferable that the insulating polyurethane resin has a dielectric constant of 6 or less (1 MHz) and insulation-breaking voltage of 15 KV/mm or more.

The insulating polyurethane resin can be achieved by adjusting the volume eigen resistance value of the achieved insulating hardened material at 10¹⁰ Ω·cm or more, preferably, at 10¹¹ Ω·cm or more, by adjusting the oxygen content rate, the elution ion concentration, or the number of kinds of elution ions. In particular, when the volume eigen resistance value is 10¹⁰ Ω·cm or more, the insulation of the hardened material is held good, such that the hardened material can be generally sealed with the protection circuit board. The measuring of the volume eigen resistance value is performed in accordance with JISC2105. A measurement voltage of 500 V is applied to a sample (thickness: 3 mm) at 25±5° C., 65±5% RH, and a value is measured in 60 second.

As the urethane resin, polyester-based resin using polyester polyol, polyester-based resin using polyether polyol, and urethane resin using other polyol may be used. One of the materials may be used or two or more materials may be used. Further, the polyol may contain powder. As the powder, inorganic particles, such as calcium carbonate, aluminum hydroxide, aluminum oxide, silicon oxide, silicon carbide, silicon nitride, calcium silicate, magnesium silicate, and carbon, and organic high molecular particles, such as polyacrylic methyl, polyacrylic ethyl, polymetacrylic methyl, poly metacrylic ethyl, polyvinyl alcohol, carboxymethyl cellulose, polyurethane, and polyphenol, may be used. Further, single materials or compounds of them may be used. Surface treatment may be performed on the particles or the polyurethane and the polyphenol may be used as foam powder. Further, the powder bodies used in the present disclosure include porous bodies.

### (Polyol)

### (Polyester-Based)

Polyester-based polyol is a reactant of aliphatic acid and polyol. Examples of the aliphatic acid include hydroxyl-containing long chain aliphatic acid such as ricinoleic acid, oxycaproic acid, oxycaprylic acid, oxyundecanoic acid, oxylinolic acid, oxystearic acid, oxyhexanedecenoic acid, and the like.

Examples of the polyol which reacts with aliphatic acid include glycol such as ethyleneglycol, propyleneglycol, butyreneglycol, hexamethyleneglycol and diethyleneglycol; trifunctional polyol such as glycerine, trimethylolpropane and triethanolamine; tetrafunctional polyol such as diglycerine and pentaerythritol; hexafunctional polyol such as sorbitol; octafunctional polyol such as sugar; a polymer obtained by adding aliphatic, alicyclic, aromatic amine to alkyleneoxide corresponding to these polyols, or a polymer obtained by adding polyamidepolyamine to the alkyleneoxide. Of these, ricinoleic glyceride and polyesterpolyol of ricinoleic acid and 1,1,1-trimethylolpropane are preferable.

### (Polyether-Based)

The polyether-based polyol includes, for example, a polymer obtained by adding alkylene oxide such as ethylene oxide, propylene oxide, butylenes oxide, α-olefine oxide, etc. to one or more kind(s) of divalent alcohols such as ethylene glycol, diethyleneglycol, propyleneglycol, dipropyleneglycol, 1,3-butanediol, 1,4-butanediol, 4,4′-dihydroxyphenylpropane, 4,4′-dihydroxyphenylmethane, trivalent or more polyalcohol such as glycerin, 1,1,1-trimethylolpropane, 1,2,5-hexanetriol, or pentaerythritol.

### (Other Polyols)

Other polyols include a polyol where the main chain is formed of carbon-carbon, for example, acrylic polyol, polybutadienepolyol, polyisoprenepolyol, hydrogenation polybutadienepolyol; a polyol which performs graft polymerization of AN (acrylonitrile) or SM (styrene monomer) to the aforementioned polyol which is formed of carbon-carbon; polycarbonatepolyol, PTMG (polytetrmethyleneglycol). In order to form directly in a battery pack, it is preferable to use a polyether-based polyol which have high elastic recuperative power, excellent chemical resistance, and cost performance superior to carbonate-based.

### (Polyisocyanate)

Examples of the polyisocyanate which can be used include aromatic polyisocyanate, aliphatic polyisocyanate, alicyclic polyisocyanate, and the like. Examples of the aromatic polyisocyanate include diphenylmethane diisocyanate (MDI), polymethylenepolyphenylenepolyisocyanate (crude MDI), tolylrene diisocyanate (TDI), polytolylrenepolyisocyanate (crude TDI), xylene diisocyanate (XDI), naphthalene diisocyanate (NDI), and the like. Examples of the aliphatic polyisocyanate include hexamethylene diisocyanate (HDI) and the like. Examples of the alicyclic polyisocyanate include isophorone diisocyanate (IPDI) and the like. In addition, polyisocyanate (carbodiimide-modified polyisocyanate) where the polyisocyanate is modified with carbodiimide, isocyanurate-modified polyisocyanate, ethyleneoxide-modified polyisocyanate, urethane prepolymer (for example, one which is the reactive product of polyol and excess polyisocyanurate, and has an isocyanate group in the molecular end) can be used. These polymers can be used independently or in mixture. Of these, diphenylmethane diisocyanate, polymethylenepolyphenylenepolyisocyanate, carbodiimide-modified polyisocyanate, and ethyleneoxide-modified polyisocyanate are preferable.

In the battery pack, properties such as heat resistance, flame retardancy, impact resistance, and moisture barrier properties can be improved depending on shape of reactive curable resin.

For example, in a case of using urethane resin, diphenylmethazine isocyanate (MDI) which has a rigid benzene ring structure and most low molecular weight isocyanate, is used as a hard segment structure, a weight mixed ratio (base resin/curing agent) of polyol as a base resin to isocynate as a curing agent is equal to or lower than 1, preferably equal to or lower than 0.7. Thereby, a molecular chain structure having high crosslink density, rigid and symmetric properties is obtained, a resin which has heat resistance and good structural strength, increase of flame retardancy due to urethane bond, and high liquid-injecting property is obtained.

However, the more diphenylmethazineisocyanate (MDI) component is, it has excellent properties from the viewpoint of strength or moisture barrier properties, but when the amount is more than 80% by weight, hard segment structure due to MDI is too increased and thus impact resistance is deteriorated. In a case where weather resistance is necessary, XDI-based, IPDI-based, or HDI-based which is polyisoamide having non-yellow modification is preferably mixed to MDI. In order to increase a crosslink density, low molecular trimethylolpropane as a crosslink agent is added to a base resin.

The reaction-curable resin is acquired from JISK-7110IzodV notch, and is preferably has impact strength of 6 kJ/m² or more, and more preferably 10 kJ/m² or more. This is because the reaction-curable resin has excellent properties for a 1.9 m falling test and a 1 m falling test, when the impact strength is 6 kJ/m² or more. This is because very excellent properties can be acquired from a falling test of which the possibility of the highest in the market, when the impact strength is 10 kJ/m² or more. When the molecular weight distribution (average molecular weight/weight average molecular weight) is high, the fluidity and formability of the resin are improved, but the impact resistance is deteriorated, such that it is preferable that the viscosity is at least 80 mPa·s or more for the fluidity and it can be appropriately used by adjusting the viscosity to 200 mPa·s or more to 600 mPa·s or less, which is more preferable.

It is preferable that the reaction-curable resin ensures sintering resistance with a combustion area of 25 cm² or less, under the UL746C3/4 inch combustion experiment, at a thickness of 0.05 mm or more to under 0.4 mm.

When urethane resin is used as the reaction-curable resin, it is preferable to include the structure represented by Formula (1), as combustion-resistant polyol. Adding a combustion-resistant component into the structure of the urethane resin has an effect especially on improvement of the combustion resistance when the resin thickness is small, and the structural strength can be ensured.

PO(XR)3 Formula (1)

(R=H, alkyl group, phenyl group, X=S, O, N(CH₂)n: N is an integer of 1 or more)

Even when the urethane resin is not used, the impact resistance of the reaction-curable resin is improved and the resin contracts due to the fire of the burner by lowering the glass-transition point (glass-transition temperature) when the thickness is small, such that the substantial thickness of the resin increases and combustion becomes difficult, and accordingly, the combustion resistance can be improved. Meanwhile, when the glass-transition point is too low or too high, the strength or the safety decreases.

Accordingly, it is preferable that the glass-transition point of the reaction-curable resin is 60° C. or more and 150° C. or less and the melting temperature (decomposition temperature) is 200° C. or more and 400° C. or less. Further, it is preferable that the glass-transition point is 85° C. or more and 120° C. or less. It is preferable that the melting temperature (decomposition temperature) is 240° C. or more and 300° C. or less. When the glass-transition point is under 60° C., it is difficult to ensure strength for the exterior packaging at an ambient temperature of 45° C. When the glass-transition point exceeds 150° C., the battery discharges the accumulated energy late in an improper use, which may cause a severe accident.

When the melting temperature (decomposition temperature) is 200° C. or more and 400° C. or less, even if the glass-transition temperature is 60° C. or more and 150° C. or less, the combustion resistance is improved by contribution of endothermic reaction by melting decomposition. When the melting (decomposition) temperature is 200° C. or less, carbonization is accelerated and heat is absorbed at the early state of the formation of the thermal-insulating layer, which may not contribute to the combustion resistance. The timing is too late even if the melting (decomposition) temperature exceeds 400° C., such that it may also not contribute to the combustion resistance.

It is preferable that the viscosity of the reaction-curable resin is 80 mPa·s or more and under 1000 mPa·s. It is possible to restrain bad coating of the maximum surface of the battery by adjusting the viscosity within the range, such that it is possible to restrain deterioration of the characteristics of the battery pack. Further, the reaction-curable resin takes a longer time to harden than the thermoplastic resin, the fluidity is excellent. However, the high viscosity increases the holding force, such that the cost of the producing apparatus increases and the productivity decreases; therefore, it may be difficult to improve the volume energy density and decrease the cost by reducing the thickness of the formed member of the pack. On the contrary, since the fluidity is too high when the viscosity is too low, the production rate decreases and the level of defects may increase due to burrs from the forming mold and seepage of the resin.

The reaction-curable resin (for example, urethane resin) is adhesive and provides long-lasting adhesion to metal, such that it adheres thermoplastic resin by a polar group, such that an adamant integral structure can be achieved. Since although the thermoplastic resin also has adherence, the adhesive strength is low, and physical strengthening of adhesion and high charging pressure are necessary, but there are not these limits in the reaction-curable resin. The relationship between the adherence of the urethane resin and the agglomeration structure is unclear, but it was found that as the crosslink density increases, the adherence decreases. Therefore, it is preferable to use a member with a large amount of active hydrogen on the surface or a member with a large amount of polar groups that can easily undergo hydrogen bonding with the urethane resin, as the adhesive member.

As described above, although separation of the members are prevented by forming an undercut portion at the fitting portion for the members, it is preferable to increase the substantial adhesive surface by making the surfaces of the members rough or making a cut portion. Further, although the adherence is improved by increasing the number of polar groups on the surface, by controlling the agglomeration structure of the urethane resin at a low temperature under the hardening conditions, it is preferable to control the separability from the mold by reducing the adherence by increasing the temperature.

### (Additive)

An additive, such as a filler, a fire-retardant, an antifoam, an anti-bacterial agent, a stabilizer, a plasticizer, a thickener, an anti-mold agent, and other resin, may be contained in the reaction-curable resin.

As the fire-retardant, triethylphospate, or tris (2,3 dibromopropyl) phosphate may be used. As other additives, a filler, such as antimonous oxide and zeolite, or a colorant, such as a pigment or a dye, may be used. As other additives, a filler, such as antimonous oxide and zeolite, or a colorant, such as a pigment or a dye, may be used.

### (Catalyst)

A catalyst may be added to the reactive curable resin. The catalyst is added for reaction of isocyanate with polyol compound, or promotion of dimerization or trimerization of isocyanate, and existing catalysts can be used. Specific examples of the catalyst include tertialry amine such as triethylenediamine, 2-methyltriethylenediamine, tetramethylhex and iamine, pentamethyldiethylenetriamine, pentamethyldipropylenetriamine, pentamethylhex and iamine, dimethylaminoethylether, trimethylaminopropylethanolamine, tridimethylaminopropylhexahydrotriazine, and tertiary ammonium salts.

The metal-based isocyanuration catalyst is preferably used in range of equal to or more than 0.5 parts by weight and equal to less than 20 parts by weight, with respect to 100 parts by weight of polyol. When the metal-based isocyanuration catalyst is less than 0.5 parts by weight, sufficient levels of isocyanuration does not occur, which is not preferable. Even when the amount of metal-based isocyanuration catalyst with respect to 100 parts by weight of polyol is more than 20 parts by weight, an effect in response to the additive amount is not obtained.

Examples of the metal-based isocyanuration catalyst include aliphatic metal salts, and specifically dibutyltin dilaurate, lead octoate, potassium ricinolate, sodium ricinolate, potassium stearate, sodium stearate, potassium oleate, sodium oleate, potassium acetate, sodium acetate, potassium naphthenate, sodium naphthenate, potassium octylate, sodium octylate, and these mixtures.

Other catalysts use organic tin compound, for example, tri-n-butyltinacetate, n-butyltintrichloride, dimethyltin dichloride, dibutyltindichloride, trimethyltin hydroxide, and the like. These catalysts may be used as they are, or dissolved to have concentration of 0.1% to 20% in solvents such as ethyl acetate, and may be added to have 0.01 to 1 part by weight as a solid content with respect to 100 parts by weight. In this way, when the aforementioned catalyst is used as it is or mixed in a dissolved state, it may be added to have 0.01 to 1 part by weight as a solid content with respect to 100 parts by weight, preferably 0.05 to 0.5 parts by weight. In other words, when the amount of catalyst blended is reduced to being less than 0.01 parts by weight, a polyurethane resin forming body is slowly formed and it is difficult to form without curing to resin shape. When the amount is more than 1 part by weight, resin is extremely rapidly formed, and it is difficult to form a polymer layer for maintaining a resin shape.

### (Metallic Oxide Filler)

A metal acid oxide filler may be contained in the formed part 11. As the metallic oxide filler, silicon (Si), aluminum (Al), titanium (Ti), zirconium (Zr), zinc (Zn), and magnesium (Mg) oxides, or a compound of the oxides may be considered. The metallic oxide filler has a function of improving the hardness of the formed portion 11 and is disposed in contact with a layer including the reaction-curable resin, and for example, the metallic oxide filler may be mixed in the layer including the reaction-curable resin, in which it is preferable that the metallic oxide filler is uniformly distributed throughout the layer including the reaction-curable resin.

The amount of mixed metallic oxide can be appropriately changed in accordance with the kinds of the polymer of the layer including the reaction-curable resin. However, when the mixing amount is under 3% with respect to the weight of the layer including the reaction-curable resin, it may be difficult to sufficiently increase the hardness of the exterior packaging material. On the other hand, when the mixing amount exceeds 60%, there may be a problem in the formability or the brittleness of ceramic in manufacturing. Therefore, it is preferable to set the mixing amount of the metallic oxide filler at 2 to 50% to the weight of the layer including the reaction-curable resin.

Further, when the average grain diameter of the metallic oxide filler is small, the hardness increases and the filling property is influenced in forming, which may cause a defect in productivity. On the other hand, when the average grain diameter of the metallic oxide filler is large, it is difficult to achieve desired strength, such that it may be difficult to achieve sufficient accuracy in the dimension for a battery pack. Therefore, the average grain diameter of the metallic oxide filler is preferably set at 0.1 to 40 μm, and more preferably set at 0.2 to 20 μm.

Further, as the shape of the metal oxide filler, various shapes, such as a sphere, a squama, a plate, or a needle. In particular, though not limited, a sphere is preferable because it is possible to achieve a filler having a particle diameter to be easily manufactured and a needle having a high aspect ratio is preferable because it is possible to easily increase the strength as a filler. Further, a squama is preferable because it is possible to chargeability when increasing the content of the filler. Further, it may be possible to mix and use fillers of which the usage, materials, or average particle diameters are different, or mix and use fillers having different shapes.

The formed portion 11 can contains various additives, other than the metal oxide. For example, it may be possible to add an ultraviolet absorbent, a light stabilizer, a hardener, or desired mixtures of them to coexist with the metal oxide.

### (As for Spacer)

In the example described with reference to FIGS. 1 and 4, the spacers 12 having the dimension-absorbing ability are disposed at four positions on the main surface of the battery component 31. However, the position and the shape of the spacers 12 are can be appropriately changed in accordance with the size and shape of the battery component.

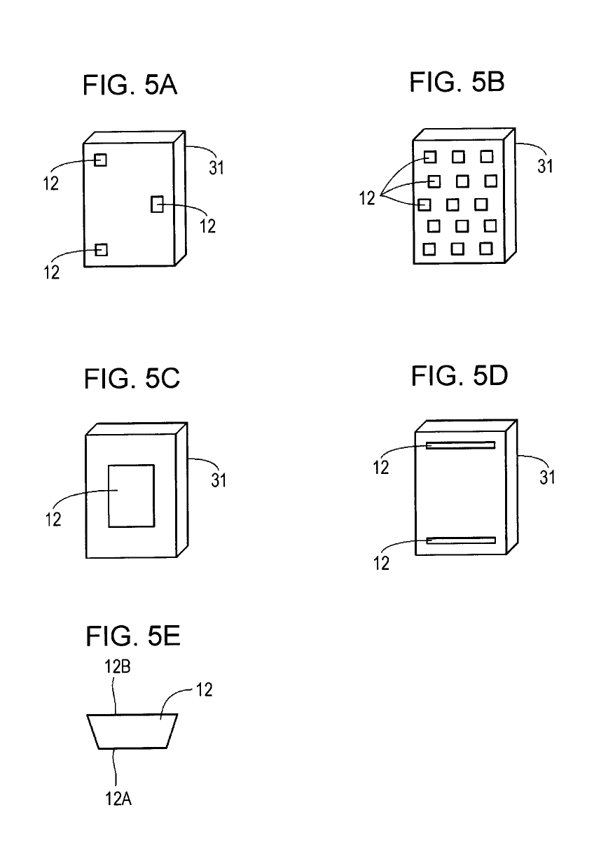

FIG. 5 is a view showing a plurality of examples of the positions where the spacers 12 are disposed. FIG. 5A is an example when the spacers 12 are disposed at three positions on the surface and the rear surface of the battery component 31, respectively. FIG. 5B is an example when the spacers 12 are disposed at fifteen positions on the surface and the rear surface of the battery component 31, respectively. FIG. 5C is an example when relatively large rectangular spacers 12 are disposed on the surface and the rear surface of the battery component 31, respectively. FIG. 5D is an example when spacers 12 that extends along the short sides on the surface and the rear surface of the battery component 31, respectively.

The spacers 12, as shown in FIG. 5E, each is shaped to have a contact surface 12A with the battery component and a contact surface 12B with the mold in which the area of the contact surface 12A and the area of the contact surface 12B are different. For example, the area of the contact surface 12B is set larger than the area of the contact surface 12A.

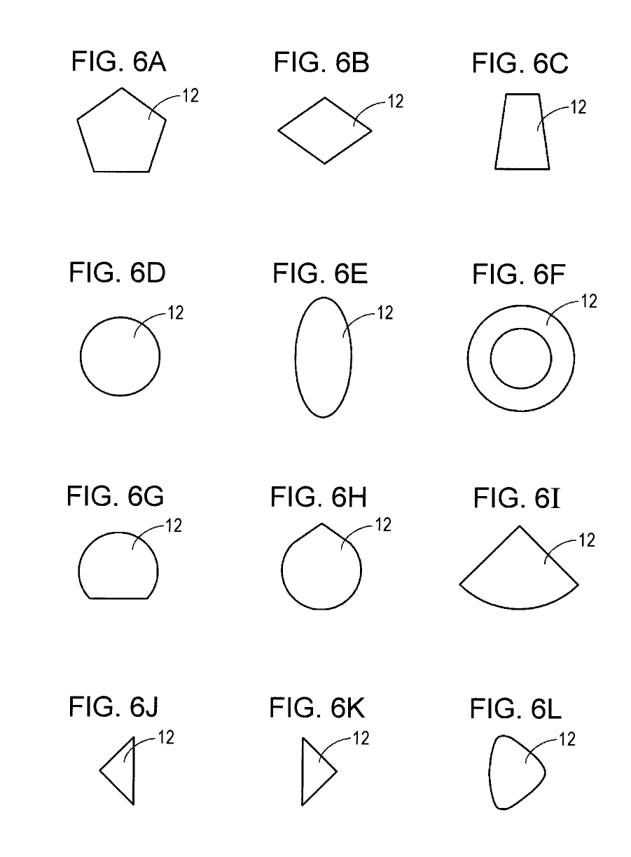

As the plan shape of the spacer 12, various shapes shown in FIG. 6, other than the rectangle, are possible. The spacer 12 shown in FIG. 6A is a pentagonal spacer. The spacer 12 shown in FIG. 6B is a rhombus spacer. The spacer 12 shown in FIG. 6C is a trapezoidal spacer. The spacer 12 shown in FIG. 6D is a circular spacer. The spacer 12 shown in FIG. 6E is an elliptical spacer. The spacer 12 shown in FIG. 6F is a ring-shaped spacer.

Further, the spacer 12 shown in FIG. 6G is a spacer having circular shape with a side cut. The spacer 12 shown in FIG. 6H is a tear-shaped spacer. The spacer 12 shown in FIG. 6I is a fan-shaped spacer. The spacer 12 shown in FIG. 6J is a triangular spacer having a shape tapered toward the outer edge of the battery component 31. The spacer 12 shown in FIG. 6K is a triangular spacer having a shape widening toward the outer edge of the battery component 31. The spacer 12 shown in FIG. 6L is a spacer having a triangular shape with a round apex.

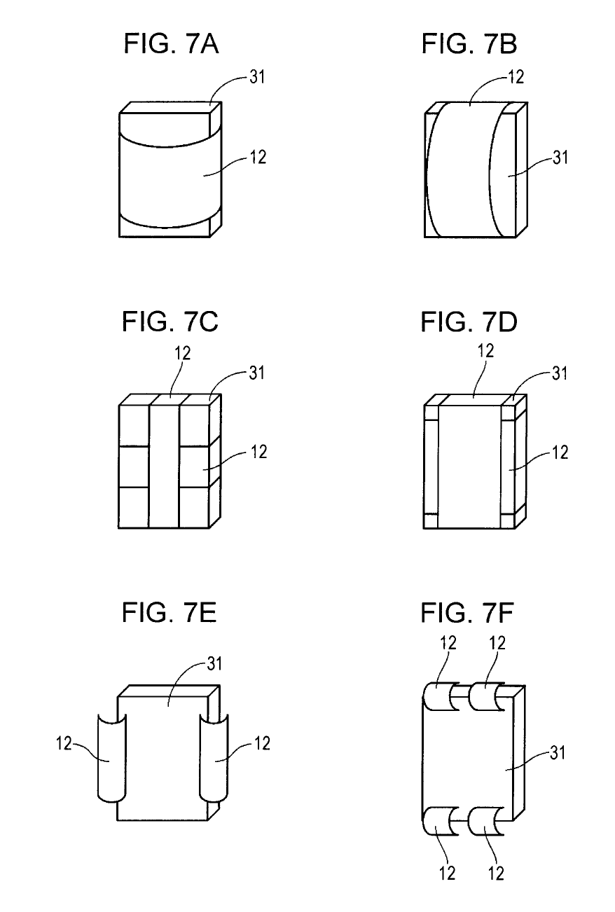

Further, modified examples of the spacers 12 are described with reference to FIG. 7. The spacer shown in FIG. 7A is a spacer wound on the four surfaces of the battery component 31. The spacer 12 shown in FIG. 7B is a spacer wound one time on the battery pack 31. In the example of FIG. 7A, the spacer 12 is wound around the surface, rear surface, and end surfaces being in contact with the long sides, while in the example of FIG. 7B, the spacer 12 is wound around the surface, rear surface, and end surfaces being in contact with the short sides.

In the example shown in FIGS. 7C and 7D, two spacers 12 wound one time around the battery component 31 are used, such that two spacers 12 cross each other. The spacers 12 shown in FIG. 7E are attached to the end surfaces being in contact with the long side, with the battery component 31 therebetween. The spacers 12 shown in FIG. 7F are attached to the end surfaces being in contact with the short side, with the battery component 31 therebetween.

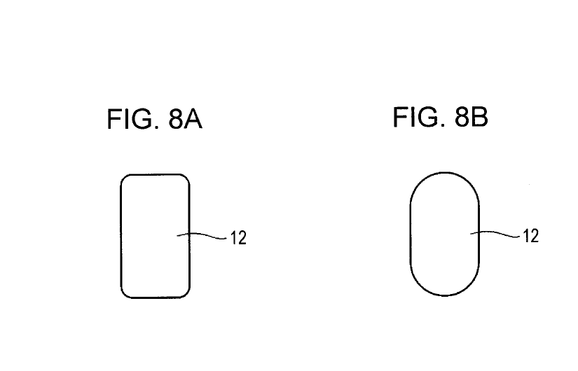

As described above, as the spacers 12 attached with the end surface of the battery component 31 therebetween, a thin rectangular spacer shown in FIG. 8A and a thin rectangular spacer with both end rounded shown in FIG. 8B are used.

When the spacer 12 blocks the channel of the resin to reduce probability of discharge of bubbles, many defective products with bad injection or bubble biting may be manufactured, such that it is possible to make the area of the spacer as small as possible. For example, it is preferable that the area of a footprint per spacer 12 is 1 cm² or less and the total area of all the spacers 12 is 10 cm² or less. It is more preferable that the area of a footprint per spacer 12 is 5 mm² or less and the total area of all the spacers 12 is 40 mm² or less.

On the other hand, when the spacer 12 is too small, it is difficult to sufficiently absorb dimensional non-uniformity of the battery surface packed by a film. This is because not only each battery has dimensional non-uniformity, but the dimensions are not uniform even in one battery. When the area of a footprint per spacer 12 is smaller than 0.5 mm², the dimensional non-uniformity further increases, such that bad filling of the resin occurs, and the battery inclines in the mold, such that the battery that is supposed to be coated is exposed to the package surface or non-uniformity in thickness of the package may increase.

The spacer 12 is preferably made of a thready material, a rubbery material, a material that can be dissolved with prepolymer of reaction-curable resin, and spring-shaped material, metal, ceramic, and resin may be used. When the dimension-absorbing ability of the spacer 12 is 3% or more, it is possible to a battery pack even for a battery element having fourteen or more layers of positive and negative electrodes. More preferably, it is preferable to allow a dimensional change of 15% or more. When the dimensional change is above 50%, the position of the battery component 31 is deviated by the discharge pressure of the injected resin, such that the battery component 31 protrudes from the formed portion 11 or the thickness of the formed portion 11 becomes non-uniform. Therefore, it is preferable to suppress the dimensional change at 40% or less.

Since the dimension of the spacer 12 is thicker than in the mold when a mold clamping force of the mold is not applied, it is excellent for the vertical stability of the battery component 31 in positioning in the mold. Further, since there is horizontal stability in positioning in the metal and the battery component 31 does not deviate in the mold 31, there is no protrusion of the battery element and bad turning of the resin, which is preferable. In order to prevent horizontal deviation, the contact between the spacer 12 and the surface of the packed battery component 31 and the close contact of the mold and the spacer 12 are increased. Therefore, it is preferable that double-sided tape or rubber is used as the spacer 12 or one side is a bonding side and the other side is made or rubber. Similarly, it is possible to prevent horizontal position deviation by increasing the friction coefficient by making the surface of the mold or the battery component 31 rough and making the surface of the spacer 12 rough. In the spacer 12 that is deformed by heat, the spacer 12 is deformed in the shape of the mold on the mold surface that is heated and the close contact increases, such that it is possible to prevent horizontal position deviation, which is preferable.

It is preferable that as a spacer 12 having dimension-absorbing ability the spacer 12 is formed by stacking firberform materials such that holes are formed therein. Since the spacer 12 is larger in strength than the filled reaction-curable resin, the resin is impregnated due to the hole therein and the package strength increases. Further, by using the fiberform spacer, the elastic limit range of the resin against tensile stress and compression stress in extension/compression when the battery pack is charged/discharged increases, which is preferable. It is more preferable that the fiberform material is any one or more of a silica fiber, a glass fiber, a carbon fiber, an alumina fiber, an acetate resin fiber, and a polyester fiber. It is possible to prevent combustion when the battery pack is burned under an abnormal environment by adding an existing fire-retardant into the acetate fiber or the polyester fiber, which is preferable.

It is more preferable that the fiberform materials make two or more layers of meshes. As the fiber is thin and the number of weaving increases, not only the cost of the spacer 12 increases, but impregnation of the resin and removal of bubbles become difficult, such that a defect in the external appearance occurs due to bubble biting and forming yield ratio may be decreased. On the contrary, when the fiberform meshes are formed in seven layers or more, not only it is difficult to remove bubbles, but the cost of the raw material of the spacer 12 may increase.

As anther example of the spacer 12, a rubbery material having 3% or more deformation due to the mold clamping force of the mold may be used. As the rubber material is an elastomer and preferably made of any one or more of urethane rubber, silicon rubber, acryl rubber, nitryl rubber, ethylene propylene rubber, styrene propylene rubber, isoprene rubber, polybutadiene rubber, and polyisobutylene rubber.

It is preferable that the shape of the rubbery spacer 12 is an undercut structure in which the mold contact area is larger than the battery contact area, as compared with the contact surface with the battery component of a film package with the mold contact area. When the rubber spacer 12 is used, it is possible to prevent a defect in the exterior due to easier bulging of the spacer than the resin exterior surface after forming, and separation of the spacer 12 due to long-time use because the spacer 12 increases the bonding force of the surface that is softer than the resin exterior surface.

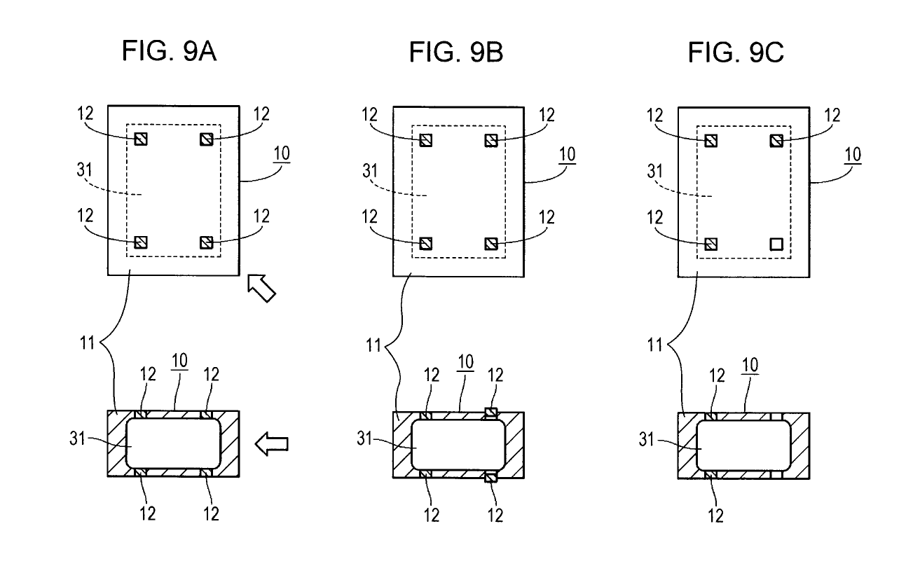

The spacer 12 of the present disclosure may also be used as a drop sensor. As the spacer, a spacer 12 of which the bonding force with the exterior resin suppressed, more preferably of which a difference in degree of solubility parameter (SP value) with the resin is 7 or more is used. As indicated by an arrow in FIG. 9A, and as described above, impact is applied to the corners of the battery pack 10 having the spacers 12 at four corners. Accordingly, as shown in FIG. 9B, a portion of the spacer 12 the closest to the position where the impact is applied comes out of the formed portion 11. Alternatively, as shown in FIG. 9C, the spacer 12 the closest to the position where the impact is applied is separated from the battery pack 10. Therefore, it is possible to determine whether impact has been applied, from the state of the spacers 12 of the battery pack 10. That is, it is possible to use the spacer 12 as a drop sensor.

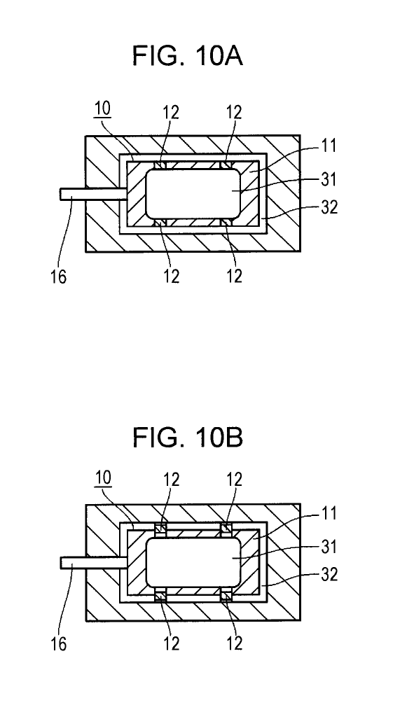

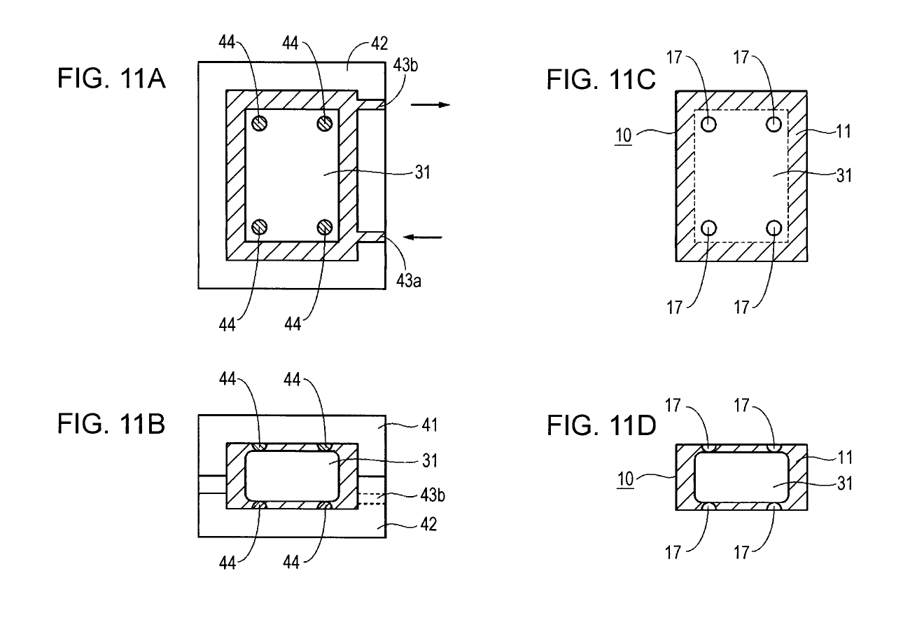

Further, since a portion of the spacer 12 protrudes when vibration or impact is applied to the electronic device, with the battery pack mounted in an electronic device, it is possible to prevent a temporary power failure due to deviation of the battery pack. As shown in FIG. 10A, the battery pack 10 is held in a battery accommodating space 32a connecting pin 16 of the device is in contact with the terminal portion of the substrate in the battery pack 10.

In this state, when vibration or impact is applied to the electronic device, the connecting pin 16 and the terminal portion of the substrate are disconnected, a temporary power failure is generated. However, in the battery pack 10 of the present disclosure, as shown in FIG. 10B, since a portion of the spacer 12 protrudes from the formed portion 11, the battery pack 10 is firmly held in the battery accommodating spacer 32 and it is possible to the battery pack 10 and the connecting pin 16 from being disconnected.

Further, it is preferable that the spacer 12 is a material having a deflection temperature (regulated in JIS7191) under load of 40° C. or more to 120° C. or less and thermal deformation due to heat of the mold of 3% or more. It is preferable that the spacer 12 that is deformed by heat is made of any one or more of urethane, silicon, acryl, and epoxy. This type of spacer 12 can show a dimension-absorbing ability by softening and deformation of the positioning spacer, by heating the mold at the deflection temperature under load and sealing it, and can prevent horizontal position deviation of the battery element in the mold.

It is preferable that difference of SP values between spacer 12 and a prepolymer of the reactive curable resin is 5 or lower. Examples of the prepolymer of the reactive curable resin which is used include polyol. Examples of materials of the spacer 12 which are used include any one or more of polyvinyl acetate, polyvinyl chloride, polybutyl acrylate, nylon 6, epoxy, methyl polymethacrylate, poly n-isopropylacrylicamide, nylon 66, polyacrylonitrile, polyvinylalcohol, cellulose acetate, and cellulose. During formation of the spacer 12, it swells by the resin and has a dimension absorption ability, as well as the spacer being incorporated and formed into the resin, and thus a product which does not show an exterior joint with the spacer, and has clean exterior appearance can be provided with good productivity. Since the swollen spacer 12 is closely adhered to a battery device and a mold, positional misalignment in a horizontal direction is prevented, which is preferable.

In a case where the spacer 12 is incorporated into an exterior material, followed by thermal curing, thermal deformation does not occur, which is preferable. In a case where the spacer is cured with ultraviolet light, it is preferably transparent. When deformation does not occur during thermal curing, and high thickness dimensional accuracy is maintained, the spacer may be any of metal, glass and resin. It is not specifically limited, but resin such as acrylic resin, epoxy resin, polycarbonate or acrylonitrile-butadiene-styrene resin (ABS), polypropylene orpolyethylene, as well as metal such as aluminum and stainless steel, which have good dimensional accuracy are used as materials, or one where metal materials such as aluminum are inserted and formed into resin materials can be used.

### (Epoxy Resin)

An epoxy resin which can be used in the present application will be described. The epoxy resin is produced form an epoxy prepolymer and a curing agent. The propolymer may contain powders. Examples of the powders which can be used include inorganic particles such as calcium carbonate, aluminum hydroxide, aluminum oxide, silicon oxide, titanium oxide, silicon carbide, silicon nitride, calcium silicate, magnesium silicate, and carbon; and organic polymer particles such as methyl polyacrylate, ethyl polyacrylate, methyl polymethacrylate, ethyl polymethacrylate, polyvinylalcohol, carboxymethyl cellulose, polyurethane, and polyphenol. These powders may be used independently or in mixture. The surface treatment of the particle may be performed, and polyurethane or polyphenol may be used in the state of foam powder. The powder which can be used in the present application includes porous powders.

### (Prepolymer)

Examples of the prepolymer which may be used include existing epoxy prepolymer such as bisphenol A-based epoxy resin, bisphenol F-based epoxy resin, phenol novolak-based epoxy resin, hydrogenated bisphenol A-based epoxy resin, and cyclic aliphatic epoxy resin, and glycidyl ether of organic carboxylic acids. In the specification, one or more of these prepolymers may be used. Glycidyl ether type and glycidyl ester type is preferable from the viewpoint of curing rate, in comparison to internal epoxy types such as cyclohexeneoxide and epoxylated polybutadiene. Examples of the glycidyl ether type include epochlorohydrine fusion of bisphenol A. It is preferable to use bisphenol F type epoxy resin from the viewpoint of viscosity.

### (Curing Agent)

Examples of the curing agent include an amine modification body such as amines, and ketimine, polyamide resin, imidazoles, polymercaptan, acid anhydride, light and ultraviolet curing agent. These curing agents may be used independently, or in mixture.

### (Amines)

Examples of the amines include chain-shape aliphatic amine, cyclic aliphatic amine, and aromatic amine.

Examples of the chain-shape aliphatic amine include hexamethylenediamine such as diethylenetriamine, triethylenetetramine, tetraethylenepentamine, dipropylenediamine, diethylaminopropylamine and AMINE248, and a derivative thereof. Examples of the cyclic aliphatic amine preferably include N-aminoethylpiperazine, menthanediamine, isophoronediamine, ramilon C-260, Araldit HY-964, SCure 211 to 212, WONDAMINE HM, 1,3-bisaminomethylcyclohexan, and a derivative thereof.

Examples of the aliphatic aromatic amine preferably include, m-xylenediamine, show amineX, amine black, show amine black, show amineN, show amine1001, show amine1010, and a derivative thereof.

Examples of the aromatic amine preferably include methaphenylenediamine, diaminodiphenylmethane, diaminodiphenylsulfone, and a derivative thereof. The polymercaptane is preferably used by mixing liquid polymercaptan and polysulfide resin with amines.

Examples of the acid anhydride include phthalic anhydride, trimellitic anhydride, pyromellitic anhydride, benzophenone tetracarboxylic anhydride, ethyleneglycolbistrimellitate, glycerol tristrimellitate, maleic anhydride, tetrahydrophthalic anhydride, endomethylenetetrahydrophthalic anhydride, hexahydrophthalic anhydride, succinic anhydride, methylcyclohexene dicarboxylic anhydride, alkylstyrene-maleic anhydride copolymer, chlorendic anhydride, polyazelaic anhydride, and a derivative thereof. More preferably, examples of the acid anhydride include methyltetrahydrophthalic anhydride, methylendomethylenetetrahydrophthalic anhydride, methylbutenyltetrahydrophthalic anhydride, dodecenylsuccinic anhydride, methylhexahydrophthalic anhydride, and a derivative thereof.

Examples of the light and ultraviolet curing agent include diphenyliododium hexafluorophosphate, triphenylsulfoniumhexafluorophosphate, and a derivative thereof. In order to form directly in a battery pack, it is preferable to use acid anhydrides which have excellent chemical resistance, a rapid curing amine-based curing agent, or which is difficult to cause corrosion of substrate by an amine-based curing agent.

In the battery pack, properties such as heat resistance, flame retardancy, impact resistance, and moisture barrier properties can be improved depending on shape of reactive curable resin.

The epoxy resin has adhesiveness superior to urethane resin. However, when the epoxy resin has too strong adhesiveness, there are problems which cause deformation or exterior appearance failure of a product during de-molding, and therefore it is preferable to add an internal de-molding agent, for example, nature-based wax such as carnabau wax; polyolefine-based wax such as polyethylene wax; amdie-based wax such as montanic acid amide; ester-based wax such as montanic acid ester; silicone compound such as silicone oil; higher aliphatic acid such as stearic acid; metal salts of higher aliphatic acid such as zinc stearate.

### Modified Examples

A laminate film 27 has one or more layers of films, which may use contain a polyolefine film, in replacement of aluminum laminate film.

In this time, it is preferable to use a urethane resin as the reactive curable resin. In the urethane resin, a weight mixing ratio (base resin/curing agent) of polyol as a base resin to isocyanate as a curing agent is 1 or less, a sum of a molecular chain which is formed of diphenylmethazineisocyanate (MDI) as a base and a curing agent is at least 20% by weight or more. In this case, it is preferable that the urethane resin prominently expresses moisture barrier properties. Moreover, in the urethane resin, a weight mixed ratio (base resin/curing agent) of the urethane resin polyol as a base resin to isocyanate as a curing agent is 0.7 or less, and a sum of a molecular chain which is formed of diphenylmethazineisocyanate (MDI) and a curing agent is at least 40% by weight or more. In this case, it is preferable that the urethane resin further increases moisture barrier properties.

Since a formed portion 11 can have excellent moisture barrier properties by using these urethane resins, one or more layers of films which contain a polyolefin film can be used, in replacement of an aluminum laminate film.

The surface of polyolefin film is subjected to vacuum deposition or sputtering to form a deposition layer, to increase moisture barrier properties. Materials of forming the deposition layer which can be used include existing materials such as silica, alumina, silica, alumina, aluminum, zinc, zinc alloy, nickel, titanium, copper, and indium. In particular, aluminum is preferably used.

The aluminum laminate film should have an aluminum layer having a thickness of about 20 μm for performing drawing molding in thickness direction of a battery, and a nylon or PET layer having a thickness of about 15 μm to 30 μm for protecting the aluminum layer during the drawing molding, and it is likely to cause 10% reduction of a volume energy density of a battery pack.

On the other hand, electrolyte of a battery element 20 is not penetrated, the battery element 20 is sealed by a thin polyolefin film with moisture barrier properties, and then aluminum as a deposition layer is deposited on the surface. Therefore, an aluminum layer having a thickness of 10 μm or less which is equal to or lower than half thickness of the related art can maintain moisture barrier properties.

Since the drawing process is not performed, nylon or PET layer can be omitted, and thus battery element 20 is packaged by one or more packaging films, and then urethane resin is formed, and therefore reliability equal to or more than the related art can be ensured. Examples of the packaging film which can be used include film such as CLAIST (trade name) which mainly contains clay mineral. The film which uses clay mineral has deteriorated flexibility, but excellent barrier properties, and thus thinner thickness than that of the related art, and therefore volume energy density of a battery pack can be preferably increased.

In a laminate film package, when a sealed cross section is bent upward, there are problems where a moisture-intruded amount due to fracture of an aluminum layer and peeling of aluminum and CPP layer is increased, but there are obtained moisture barrier properties by urethane resin and superior effects where the aforementioned failures are not caused by aluminum deposition after battery sealing, and battery capacity is significantly increased. It is preferable that aluminum deposition is performed two or more times. When multilayer deposition is performed, and aluminum layer has a thickness of 1 μm or less, and reliability can be maintained. However, the thickness is lower than 0.03 μm, there are problems where pin holes on a deposition face occur, and thus it is preferable to have aluminum layer having a thickness of 0.03 μm or higher.

### (Positioning by Protrusion of Mold)

In the present disclosure, it may be possible to perform the position with a protrusion of the mold, instead of the spacer 12 or together with the spacer 12. The protrusion has a dimension-absorbing ability, as described in respect to the spacer 12, and absorbs a change in dimensions of the battery element, and can accurately hold the battery component at a predetermined position in the cavity of the mold.

Forming of the formed part 11 of the battery pack is described with reference to FIG. 11. The battery component 31 schematically showing both of the battery and the circuit board is accommodated in the cavity (forming space) of the mold of a forming apparatus. The mold is composed of an upper mold 41 and a lower mold 42 and the bonding surface of the upper mold 41 and the lower mold 42 is a flat surface. Four positioning protrusions 44 are disposed around four corners on the inner surface of the upper mold 41 opposite to the upper surface of the battery component and the inner surface of the upper mold 41 opposite to the bottom of the battery component.

For example, two gate holes 43a and 43b are formed at the lower mold 42. The gate hole 43a is a channel through which resin flows inside in forming and the gate hole 43b is a channel through which the resin is discharged in forming. The upper mold 41 and the lower mold 42 are made of metal, plastic, or ceramic.

As shown in FIGS. 11A and 11B, the cavity for forming is defined by both of the upper mold 41 and the lower mold 42 and the battery component 31 is accommodated in the cavity. Reaction-curable resin under 120° C. that becomes the formed part 11 is injected into the cavity from the gate hole 43a and discharged from the gate hole 43b. As shown in FIGS. 11C and 11D, after the resin is hardened, the upper mold 41 and the lower mold 42 are separated and the battery pack 10 with the battery component 31 coated with the formed part 11 is formed. Further, in FIGS. 11A and 11B, the protrusions 44 and the resin are indicated by hatch lines.

Since the spacers 44 has the dimension-absorbing ability, it is possible to firmly hold the battery component 31 at the predetermined position in the cavity of the mold, even if the dimension of the battery component 31 (particularly, a battery with the battery element coated with a laminate film) is not uniform. Further, the materials described above may be used for the reaction-curable resin that is filled in the cavity.

As the protrusions 4, a rubbery material that deforms 3% or more by the mold clamping force of the mold may be used. For example, the rubbery protrusion is made of an elastomer, any one or more of silicon rubber, ethylene propylene rubber, styrene propylene rubber, isoprene rubber, polybutadiene rubber, and polyisobutylene rubber.

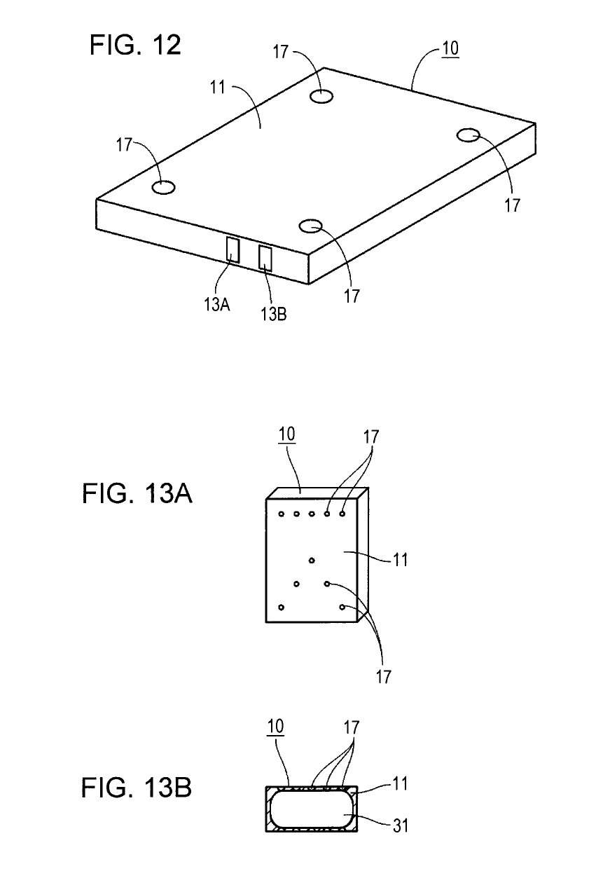

As shown in FIGS. 11C, 11D, and 12, a battery pack 10 has a flat rectangular external appearance and is coated with a forming part (exterior package) 11 in which a battery and a protection circuit board of the battery are integrally made of reaction-curable resin. A plurality of positioning marks 17 is formed on the main surfaces (the top and the bottom) of the formed part 11 of the battery pack 10.

A preferable shape of the protrusion 44 of the mold is that the area of the surface being in contact with the battery component 31 is smaller than the area of the base. As a result, the area of an opening of the positioning mark 17 is larger than the area of the bottom where the battery component 31 is exposed. Further, it is preferable that the protrusion 44 has a cup shape, a conical shape with the tip removed. Further, as the protrusion 44, a pyramid shape with the tip removed.

### Example of Protrusion of Mold and Positioning Mark

FIGS. 13A and 13B are examples when positioning marks 17 are formed at ten positions on one main surface by protrusions 44 having a conical shape with the tip removed. The protrusion 44 has dimension-absorbing ability.

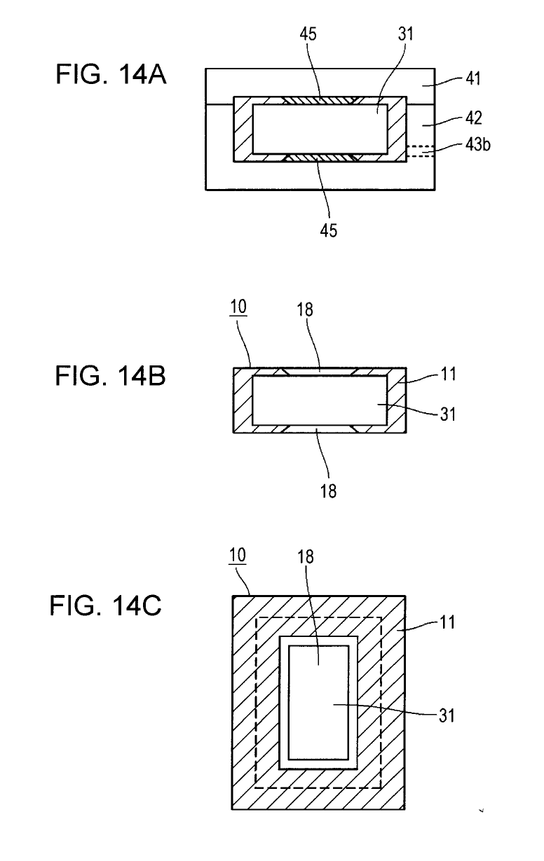

As shown in FIG. 14A, position protrusions 45 having a pyramid shape are formed on the inner surface opposite to the main surface of the battery component 31 of each of the upper mold 41 and the lower mold 42. The protrusion 45 has dimension-absorbing ability. As shown in FIGS. 14B and 14C, a battery pack 10 having positioning marks 18 having a rectangular opening at the center portion of the main surface is manufactured by the protrusions 45.

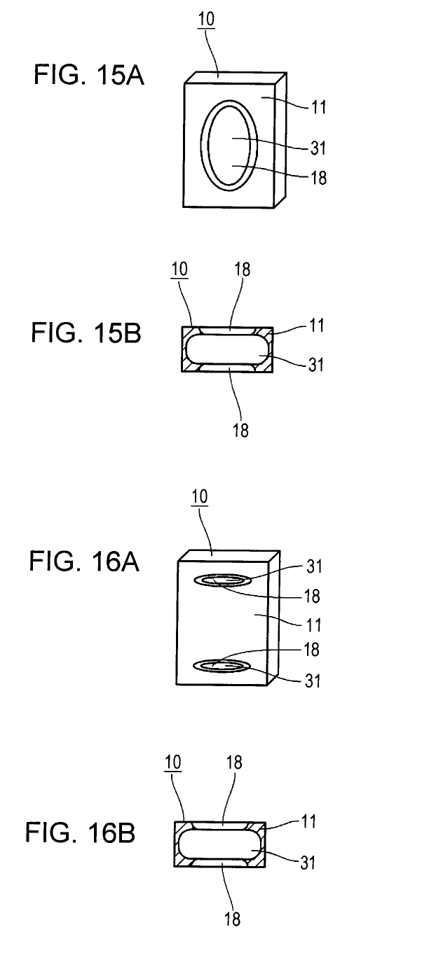

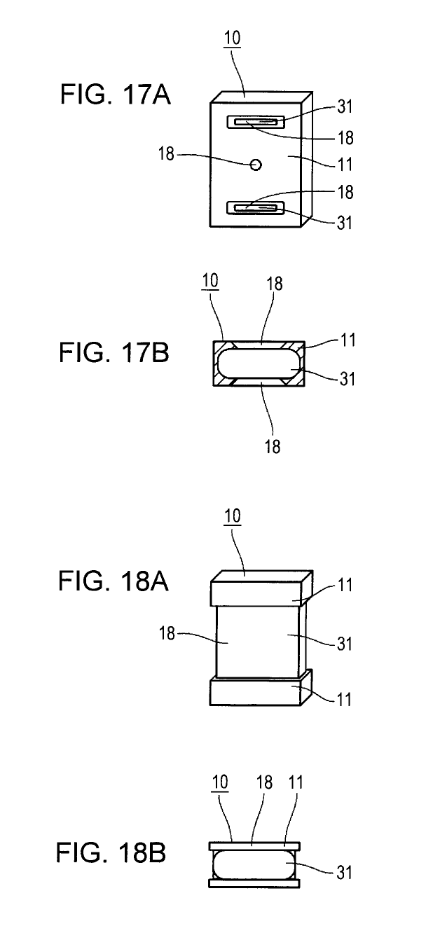

As shown in FIGS. 15A and 15B, a battery pack 10 having positioning marks 18 having an elliptical opening at the center portion of the main surface is manufactured by a mold having a conical protrusion. A mold having two protrusions having an elliptical conical shape. In this case, as shown in FIGS. 16A and 16B, a battery pack 10 having positioning marks 18 having an elliptical opening at upper and lower positions of the main surface is manufactured. The battery pack 10 shown in FIGS. 17A and 17B is an example manufactured by a mold having two protrusions having a pyramid shape.

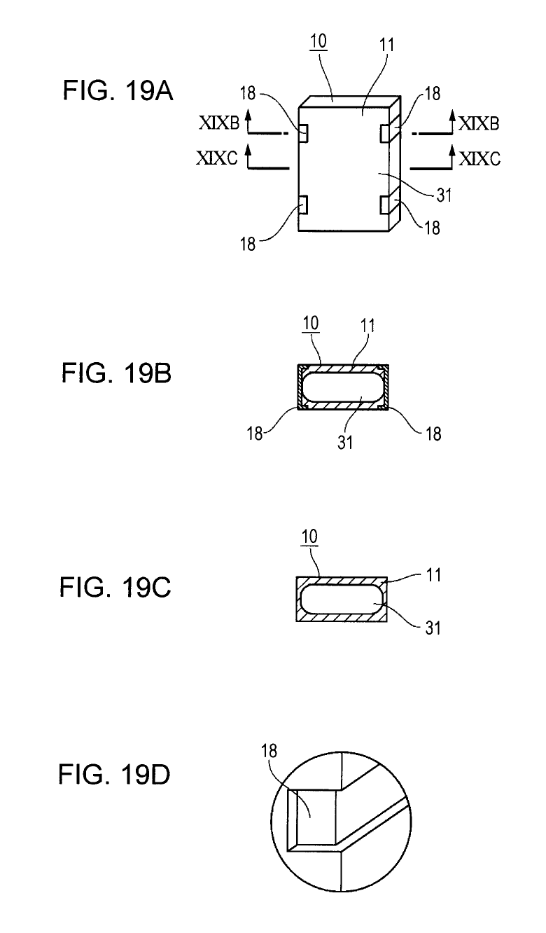

Further, as shown in FIGS. 18A and 18B, the formed portion 11 may be formed at the front and rear end portions and the surface, except for both ends of the batter part 31, may be exposed. The battery pack 10 shown in FIGS. 19A to 19D has two positioning marks 18 (enlarged in FIG. 19D) at two end surfaces being in contact with the long sides. Positioning marks 18 (enlarged in FIG. 19D) at two end surface being in contact with the long sides. FIG. 19B shows a cross-section taken along the line XIXB-XIXB in FIG. 19A and FIG. 19C shows a cross-section taken along the line XIXC-XIXC in FIG. 19A. As shown in FIG. 19, when a protrusion being in contact with the three surfaces of the battery pack 31 is formed at a mold, positioning is possible in both vertical and horizontal directions and dimension-absorbing ability may be provided in both directions.

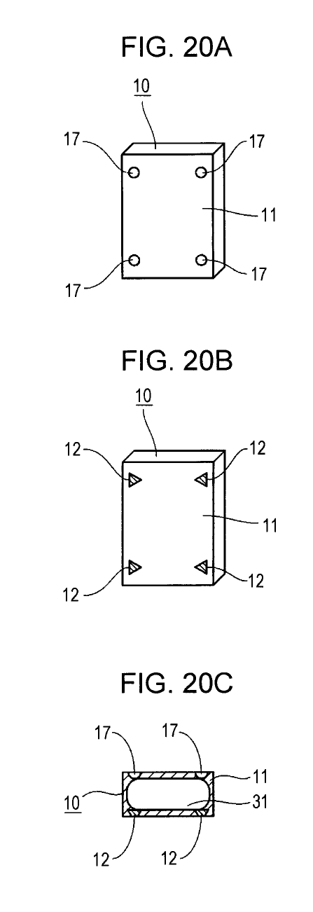

Further, as shown in FIG. 20, the positioning by the spacers 12 described above and the positioning by the protrusions of the mold may be simultaneously used. In this case, as shown in FIG. 20A, the positioning marks 17 are formed on one of the main surfaces of the battery pack 10 and the spacers 12 are formed on the other one of the main surfaces, as shown in FIG. 20B. Further, various positions and shapes described above may be used for the position of the spacer 12 and the shape of the spacer 12. Further, various protrusions described above may also be used for the protrusions of the mold and the positioning mark 17 has a shape corresponding to the protrusions.

### (In-Mold Molding)

As in the present disclosure, when the exterior formed portion 11 is resin-formed, a film for anticounterfeit, water detection, or authentication may be in-molded on the entire or a portion of inner side of the formed portion 11. The producer directly in-molding a seal, confusion of the origin, reduction of productivity, and reduction of volume energy density are prevented.

The reaction-curable resin is preferably hard resin with a high crosslink density, and accordingly, it is preferable to use resin with a high water barrier property. A scratch-resistant film, such as nylon or a polyethyleneterephthalate, is generally formed on the surface of the film for anticounterfeit, water detection, or authentication. However, since the seal of the present disclosure is enclosed by the external resin, the surface film may not be provided, such that the cost is reduced, which is preferable.

When a water detection seal is enclosed, in-molding is performed such that the rubbery protrusion of the mold faces a portion of the edge without being coated with the water detection seal, water permeates into the edge without being coated with the resin when it is sunk in water by an improper use, such that it is possible to determine an improper use. As a photosensitive material of a hologram seal used in the present disclosure, a silver salt compound, bichromatic gelatin emulsion, photopolymerizable resin, and photocrosslinkable resin, may be used. However, when in-molding is performed by using thermoplastic resin, an inexpensive material in which a photosensitive material is deteriorated at a high temperature of 120° C. or more could not be used. In the present disclosure, it is possible to use an inexpensive photosensitive material because forming is performed at a low temperature less than 120° C. Further, since reliability and the battery properties of the battery pack may be deteriorate at an improper use temperature of 60° C. or more, it is preferable to also provide a thermal paper, but it is possible to achieve the function of the thermal paper by appropriately setting a deterioration temperature of the photosensitive material of the hologram, such that it is possible to contribute to improving the volume energy density of the battery pack, in addition to reducing the cost.

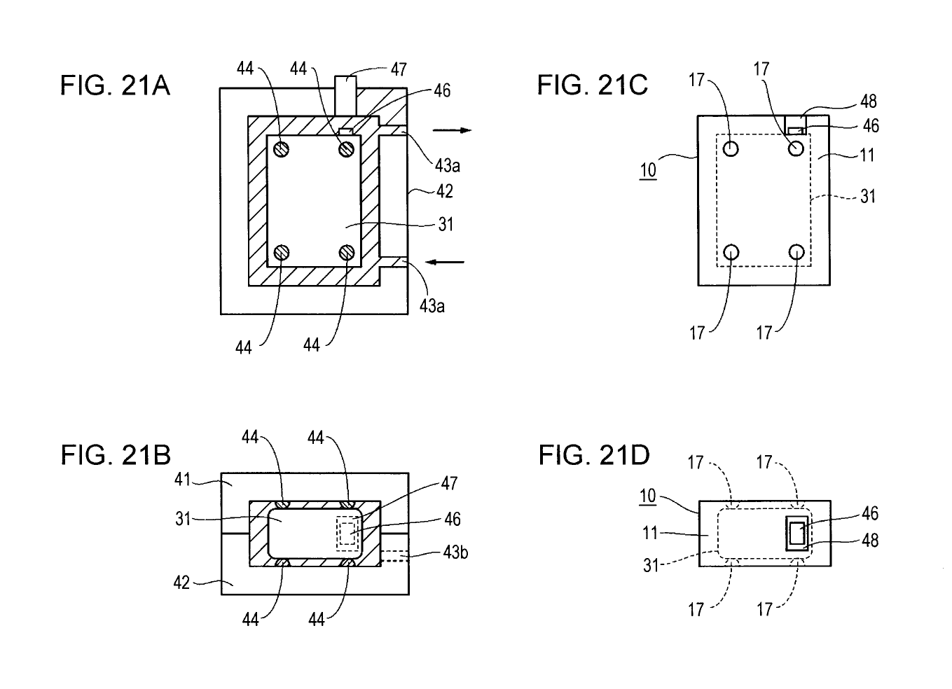

In the present disclosure, it is possible to only slightly increase transmittance of resin by changing the reaction-curing conditions of only a portion of the resin to change the crosslink density, by using the reaction-curable resin. For example, as shown in FIGS. 21A and 21B, a portion 47 of the mold corresponding to the position of the seal 46 is cooled and formed. By this process, as shown in FIGS. 21C and 21D, it is possible to prevent whitening by decreasing the crosslink density of only the resin 48 on the seal 46 of the in-molded inside. Therefore, making the resin 46 transparent can increase the volume energy density of the battery pack and improve visibility.

### (Influence of Spacer)

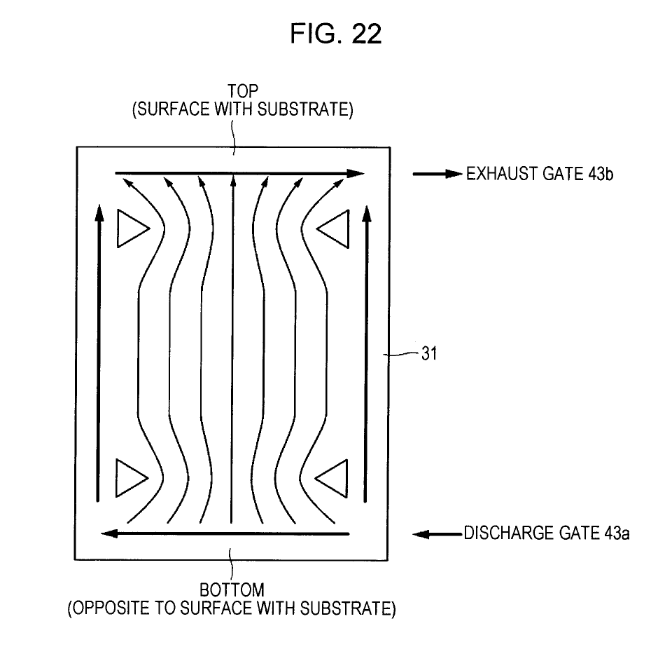

FIG. 22 schematically shows a channel of resin when resin-molding. The spacer 12 partially blocks the channel of resin, as can be seen from the flow line of resin. Therefore, bad injection and an external defect, such as bubble biting, are generated unless the shape of the spacers 12, the size of the spacers 12, the total area of the spacers 12, the positions of the spacer 12, and the arrangement direction of the spacers 12 are appropriately set. In the present disclosure, in embodiment, the parameters of the spacers 12 are optimally set.

### Another Example of Protrusion of Mold and Positioning Mark

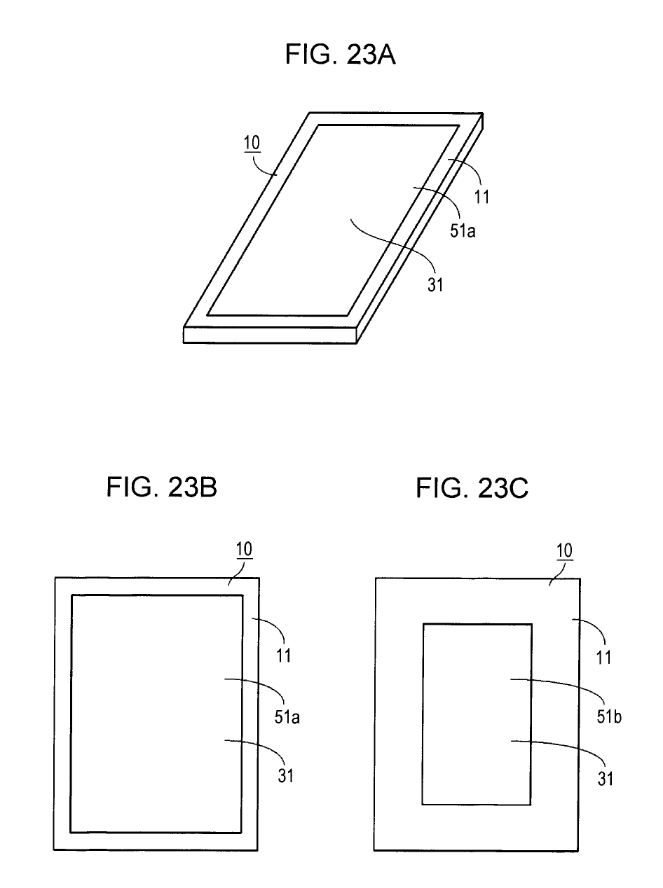

As described above, a battery pack having rectangular openings 51a and 51b as positioning marks at the center portion of the main surface, as shown in FIG. 23, by the protrusions having dimension-absorbing ability and disposed on the mold. As shown in FIGS. 23A, 23B, and 23C, the opening 51a on a main surface is larger in area than the opening 51b on the other main surface. The formed portion 11 is formed in a frame shape and at least the thickest portion of the battery component 31 is exposed through the openings.

The battery component 31, as described above, is implemented by packing the protection circuit board and the battery element with a film package. Further, in the same way as described above, the formed portion 11 can be discharged at a low temperature less than 120° C. and a low pressure less than 10 kgf by the reaction-curable resin. Further, as described above, as the reaction-curable resin, at least one kind selected from urethane resin, epoxy resin, acryl resin, silicon resin, and dicyclopentadiene resin may be considered. In the resin, at least one selected from the urethane resin, epoxy resin, acryl resin, and silicon resin is preferable. The glass transition temperature after the forming is 60° C. or more and 140° C. or less.

The urethane resin is made of polyol and polyisocyanate. It is preferable to use the insulating polyurethane resin defined below as the urethane resin. The insulating polyurethane resin means a substance from which a hardened substance having a volume eigen value (Ω·cm) of 10¹⁰ Ω·cm or more, which is measured at 25±5° C., 65±5% RH. It is preferable that the insulating polyurethane resin has a dielectric constant of 6 or less (1 MHz) and insulation-breaking voltage of 15 KV/mm or more.

As the urethane resin, polyester-based resin using polyester polyol, polyester-based resin using polyether polyol, and urethane resin using other polyol may be used. One of the materials may be used or two or more materials may be used. Further, the polyol may contain powder.

In polyamide or polyurethane that is formed at 130° C. or more, the battery, a PTC that is a protective element, and a temperature fuse may be deteriorated, and the fluidity is low, such that the resin becomes thick and it is difficult to achieve high the energy density. Further, in polyolefin that has to be 300° C. or more, in addition to the problem, there is no adhesiveness, there is a problem in holding a battery that extends/contracts by charging/discharging and holding a substrate under vibration. Meanwhile, when polyamide is used, in rubbery resin that satisfies an impact resistance, strength for fitting and bonding is not satisfied, such that a fitting and bonding structure is not accomplished. For strength of achieving a fitting and bonding structure, impact resistance decreases, such that breaking of the parts and terminals is not avoidable in a device mounting/falling test.

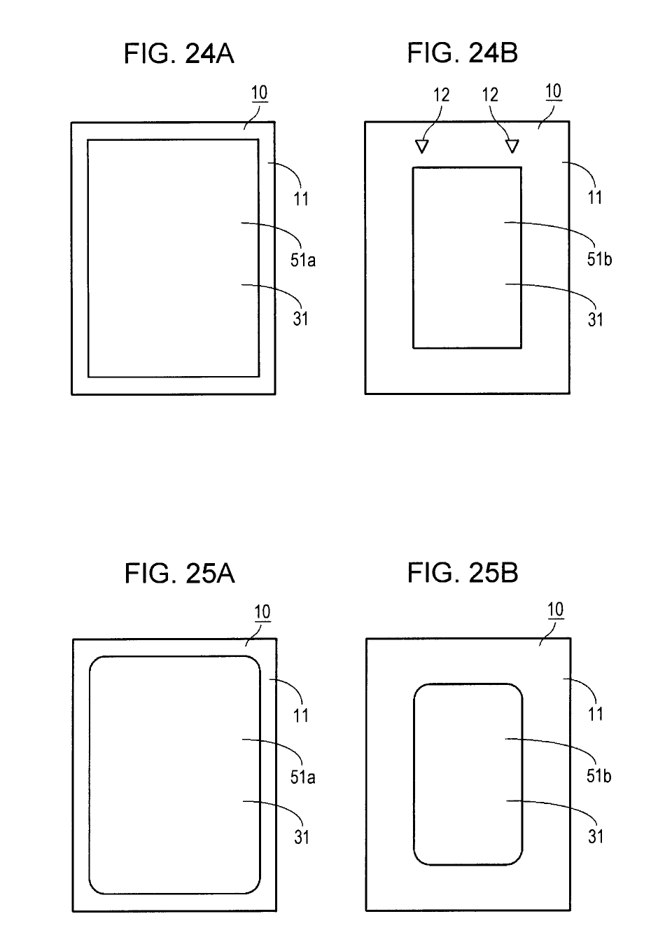

As shown in FIGS. 24A and 24B, the spacers 12 may be provided for the frame-shaped formed portion 11. The shape, number, and position of the spacers 12 are not limited, as shown in FIG. 24, the spacers 12 described above may be used. Further, as shown in FIGS. 25A and 25B, the shape of the openings 51a and 51b is not limited to a rectangle and may be a rectangle with rounded corners.

As shown in FIGS. 14, 23, 24, and 25 described above, it is possible to increase the energy density of the battery pack and easily dissipate heat by implementing the formed portion 11 such that the openings are formed at the main surfaces (surface and rear surface) of the battery component 31. When a heat dissipation property is good, in a battery pack or an electronic device using a battery pack, it is possible to use a CPU having high performance but generating a large amount of heat. The strength (rigidity and impact resistance) decreases, but for example, in a battery pack disposed in a portable device not to be directly replaced by a consumer, strength against torsion deformation is not necessary as an exterior, such that a merit is not that large in strength. Further, it is not necessary to coat the top with resin, it is possible to reduce bad resin coating.

### (Relationship Between Seal Portion and Formed Portion of Film Package)

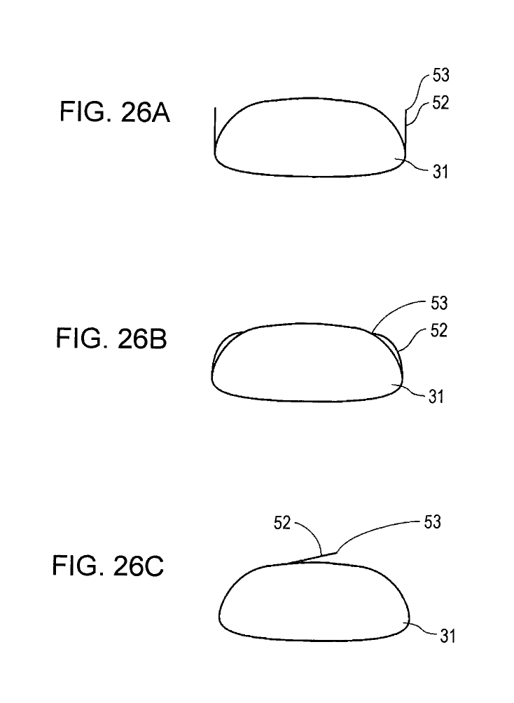

As described above, a laminate film 27 (see FIG. 2) is used as a film package and the periphery of the recess 27a where the battery element 20 is accommodated is deposited. The peripheral deposited portion is referred to as a terrace portion or a seal portion (hereinafter, referred to as a seal portion) and the seal portion 52, as shown in FIG. 26A, is bent at a substantially right angle toward the recess. The seal portion 52 has an end surface 53 and water may permeate from the outside through the end surface 53. Further, in FIG. 26A, a transverse cross-section of the battery component 31 packed by a laminate film is shown.

The seal portion 52 has a large seal area where the laminate film overlaps to prevent permeation of water, such that as shown in FIG. 26C, it is preferable that the seal portion 52 is on the top. However, in view of volume energy density, as shown in FIG. 26A, it is preferable to dispose the seal portion 52 to the side, and as described above, it is more preferable that the seals are disposed at three sides to prevent reduction of volume energy density by the seal portion 52. Further, as shown in FIG. 26B, the seal portion 53a disposing at a substantially right angle may be bent along the surface of the battery component 31.

As described above, when the formed portion 11 is implemented to have the openings on the main surfaces (surface and rear surface) of the battery component 31, the end surface 53 of the seal portion 52 bent along the surface of the battery component 31 is covered by the formed portion 11. By this configuration, the end 53 is closed by the formed portion 11 and it is possible to certainly prevent water from permeating from the end surface 53. Meanwhile, as shown in FIG. 26C, when the seal portion 52 is formed on the top, since the end surface 53 of the seal portion 52 can be covered by the formed portion 11 having the openings, there is a problem that seal effect is not increased by the formed portion 11.

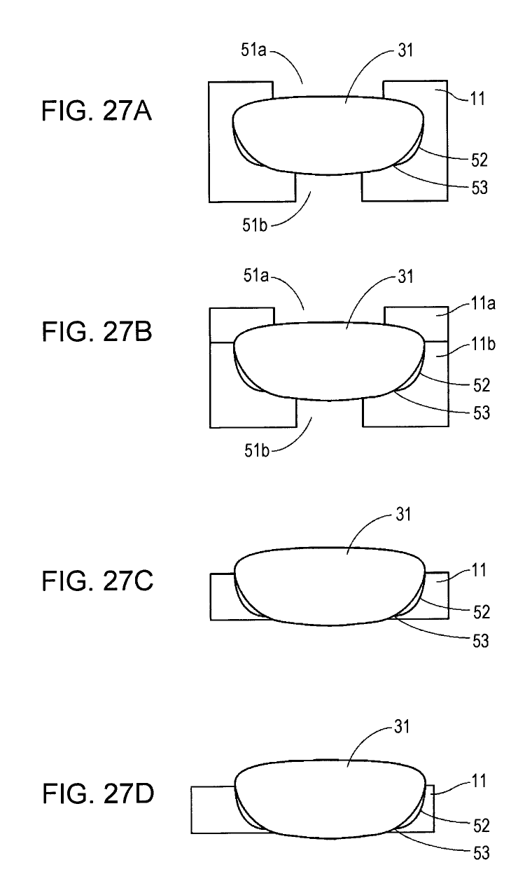

FIG. 27 shows a plurality of examples of the relationship between the formed portion and the seal portion of the film package. The example shown in FIG. 27A, as shown in FIG. 23, is an example when the formed portion 11 has the openings 51a and 51b having different areas.

In the example shown in FIG. 27B, the openings 51a and 51b having different areas are formed while the formed portion is implemented by overlapping two formed portions 11a and 11b. The lower formed portion 11a is harder than the upper formed portion 11b and the upper formed portion 11b has an impact resistance higher than the lower formed portion 11a. The colors of the formed portions 11a and 11b may be different.

The example shown in FIG. 27C is when the formed portion 11 covers the edge of the battery component 31. The formed portion 11 covers the end surface 53 of the seal portion 52. The example shown in FIG. 27D, similar to FIG. 27C, is when the height of the formed portion 11 is small. Both sides of a forming space have asymmetric cross-sections. That is, the cross-section of the side (see FIG. 22) where the discharge gate 43a and the exhaust gate 43b are disposed in the channel through which resin flows in forming is smaller in area than the opposite cross-section.

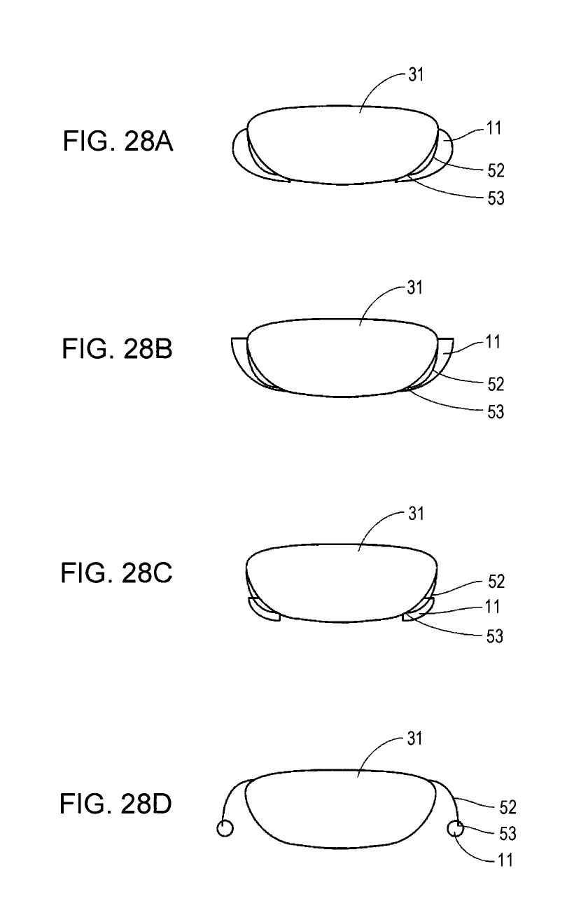

FIG. 28 shows a plurality of other examples of the relationship between the formed portion and the seal portion of the film package. The example shown in FIGS. 28A and 28B is an example when the resin of the formed portion 11 exists in the range corresponding to the seal portion 52 bent along the surface of the battery component 31.

The example shown in FIG. 28C is an example when the resin of the formed portion 11 exists in the range corresponding to substantially the half of the end surface 53 in the range corresponding to the seal portion 52.

The example shown in FIG. 28D is an example when the resin of the formed portion 11 exists only around the end surface 53 of the seal portion 52.

### (Formed Portion Having Fitting Portion or Connecting Portion for Thread-Fastening)

When the battery pack is fixed to an electronic device of the main body by a double-sided tape or an adhesive, removal for replacing the battery pack is trouble. In the present disclosure, the formed portion 11 is provided with a connecting portion or a positioning portion for freely attaching/detaching the battery pack to/from the main body in consideration of that the battery pack has the formed portion 11. The connecting portion is the fitting portion, such as a protrusion, or the connecting portion for thread-fastening formed at the main body.

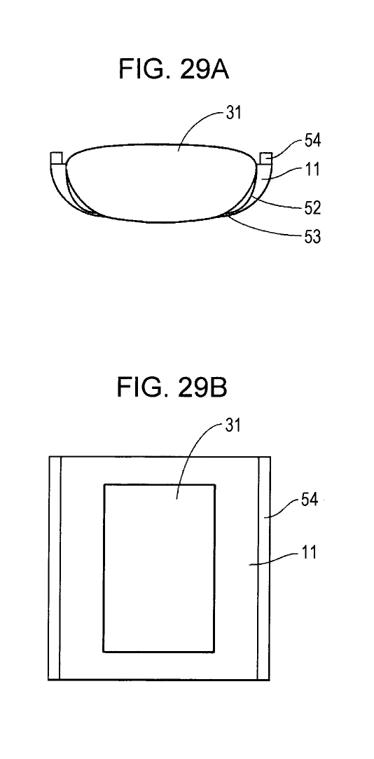

As shown in FIG. 29, the formed portion 11 is formed along the range of the seal portion 52 and the formed portion 11 covers the end surface 53 of the seal portion 52. A slit (groove) 54 extending in the longitudinal direction of the both ends of the formed portion 11 is integrally formed with the formed portion 11. The slit 54 is fitted on the protrusion (not shown) of the main body where the battery pack is mounted. The protrusion can slide in the slit 54 and the battery pack is mounted by sliding with respect to the battery pack.

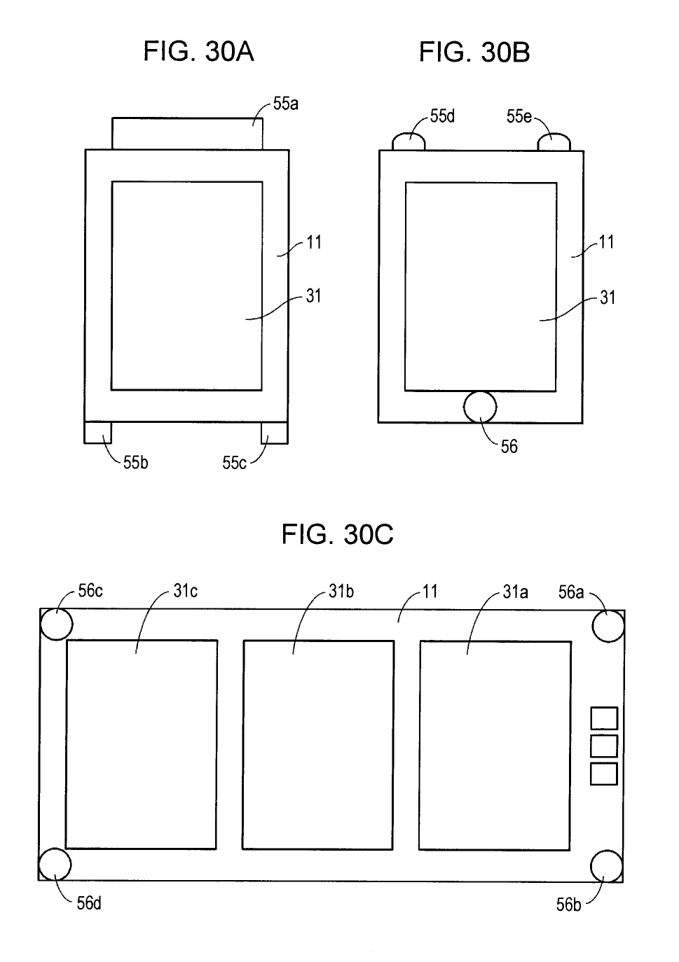

As shown in FIG. 30A, a slide fitting portion 55a is formed at one end of the formed portion 11 and slide fitting portions 55b and 55c are formed at the corners of the opposite end. As shown in FIG. 30A, slide fitting portions 55d and 55e are formed at one end of the formed portion 11 and a connecting portion for thread-fastening, such as a threaded hole 56 is formed at the corners of the opposite end. The threaded-hole 56 is formed in a region of the seal portion (terrace portion) of the battery component 31.

Further, as shown in FIG. 30C, a plurality of, for example, three battery components 31a, 31b, and 31c may be integrated by common connection 1. In this case, threaded holes 56a, 56b, 56c, and 56d are formed at four corners of the formed portion 11.

As described above, since the battery pack has the formed portion 11, it is possible to integrally form the fitting portions that is the connecting portion for attaching the battery pack to the main body or the connecting portion for thread-fastening with the formed portion 11. As a result, it is not necessary to fix the battery pack with a double-sided tape or an adhesive and it is possible to implement a battery pack that is easily mounted at a predetermined position of the main device.

Further, the exposed portion of the battery component of the battery pack of the present disclosure or the formed portion 11 and the cooling mechanism of the device are in contact, such that good heat dissipation effect is achieved. The cooling mechanism of the device may be an existing one such as a heat pipe or a cooling fan. The cooled metal parts of a module other than the battery pack in the device and the exposed portion of the battery component or the formed portion 11 of the battery pack are in contact with each other, such that good heat dissipation effect is achieved.

(Electric Connection Configuration with Outside)

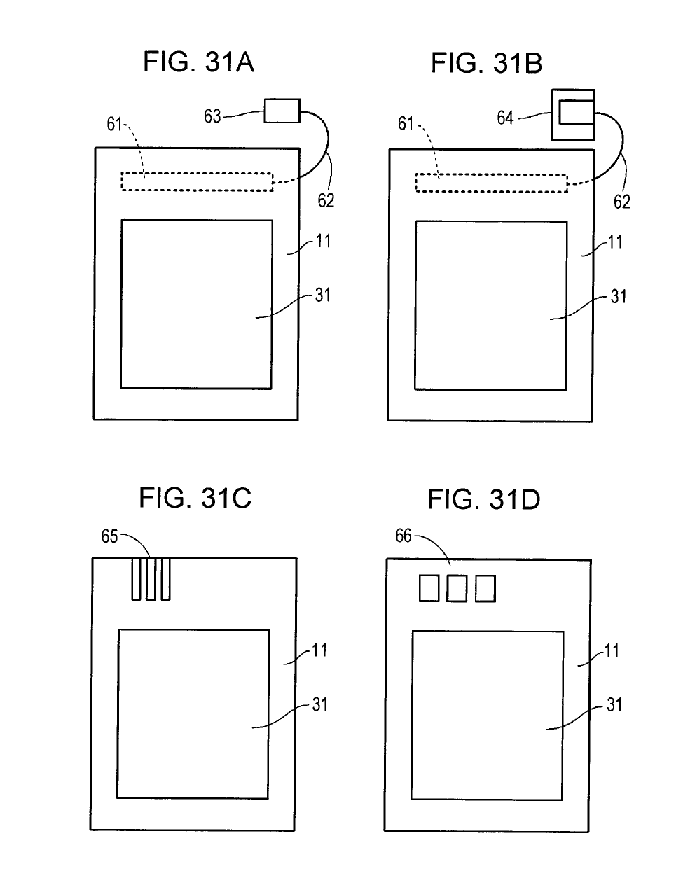

A configuration example of electric connection between the battery pack and the main device is described with reference to FIG. 31. In the example shown in FIG. 31A, a flexible wire substrate 62 is led from circuit board 61 in the battery pack and a connector 63 is connected to the front end, such that the connector 63 is connected to the terminal of the device.

In the example shown in FIG. 31B, a flexible wire substrate 62 is led from circuit board 61 in the battery pack and a connector 64 equipped with a stiffener is connected to the front end, such that the connector 64 is connected to the terminal of the device.

When the flexible wire substrate 62 is used, there is a problem in that impedance of the power supply path increases, such that the cost increases. Temporary power failure resistance is excellent.

As shown in FIG. 31C, a tabby connector 65 crossing two surfaces around the battery pack may be used. In this configuration, there is a problem in that the capacity decreases and the cost increases. Temporary power failure resistance is excellent.

As shown in FIG. 31D, a flat metal terminal surface 66 may be formed at the top of the formed portion 11. This configuration has the advantage of a low cost without decreasing the capacity. The temporary power failure resistance is lower than other electrode configurations.

Hereafter, the present disclosure is described in more detail with embodiments and comparative examples. However, the present disclosure is not limited to the embodiments.

### Embodiment 1 to Embodiment 42, Comparative Example 1 to Comparative Example 4

Initially, embodiments and comparative examples of a battery pack having the spacers 12 having the dimension-absorbing ability and a battery pack having positioning marks 7 are described with reference to Table 1. One table is divided into four table (Table 1-1, Table 1-2, Table 1-3, and Table 1-4), because there are many items to record in Table 1. Table 1-2 is continued under the Table 1-1, Table 1-3 is continued at the right side of Table 1-1, and Table 1-4 is continued at the right side of Table 1-2. Table 1-3 and Table 1-4 show estimation (effect).

TABLE 1-1

| | a | b | c | d | e | f | g |
|---|---|---|---|---|---|---|---|
| Embodiment 1 | silicon | 2.5 | FIG. 7D | acryl rubber | −30 | — | — |
| Embodiment 2 | epoxy | 51 | FIG. 7C | nitrite rubber | −35 | — | — |
| Embodiment 3 | urethane | 49 | FIG. 7A | ethylenepropylene rubber | −20 | — | — |
| Embodiment 4 | acryl | 3 | FIG. 7B | stylenepropylene rubber | −15 | — | — |
| Embodiment 5 | polyurethane | 16 | FIG. 7E | polybutadien rubber | −90 | — | — |
| Embodiment 6 | epoxy | 26 | FIG. 7F | isoprene rubber | −70 | — | — |
| Embodiment 7 | epoxy | 15 | FIG. 5C | polyisobutylene rubber | −70 | — | — |
| Embodiment 12 | polyurethane | 25 | FIG. 8A | silicon rubber | −30 | — | — |
| Embodiment 13 | polyurethane | 20 | FIG. 8B | urethane rubber | −30 | — | — |
| Embodiment 8 | polyurethane | 20 | FIG. 5B | acryl | 30 | — | — |
| Embodiment 9 | polyurethane | 20 | FIG. 5D | epoxy | 30 | — | — |
| Embodiment 10 | polyurethane | 20 | FIG. 5A | silicon | 30 | — | — |
| Embodiment 11 | polyurethane | 20 | FIG. 1 | urethane | 30 | — | — |
| Embodiment 14 | acryl | 20 | FIG. 6A | polyvinyl chloride | 30 | 18 | 19 |
| Embodiment 15 | acryl | 20 | FIG. 6B | polyvinyl acrylate | 30 | 18 | 19 |
| Embodiment 16 | acryl | 20 | FIG. 6C | polybutyl acrylate | 10 | 18 | 20 |
| Embodiment 17 | polyurethane | 20 | FIG. 6D | nylon 6 | 550 | 27 | 22 |
| Embodiment 18 | polyurethane | 20 | FIG. 6E | epoxy | 45 | 27 | 22 |
| Embodiment 19 | polyurethane | 20 | FIG. 6F | methyl polymethacrylate | 45 | 27 | 23 |
| Embodiment 20 | polyurethane | 20 | FIG. 6G | poly n-isopropylacrylicamide | 60 | 27 | 23 |
| Embodiment 21 | polyurethane | 20 | FIG. 6H | nylon 66 | 50 | 27 | 23 |
| Embodiment 22 | polyurethane | 20 | FIG. 6I | polyacrylonitrile | 100 | 30 | 26 |
| Embodiment 23 | polyurethane | 20 | FIG. 6J | polyvinylalcohol | 85 | 30 | 26 |
| Embodiment 24 | polyurethane | 20 | FIG. 6K | cellulose acetate | 70 | 33 | 28 |
| Embodiment 25 | polyurethane | 20 | FIG. 6L | cellulose | 50 | 36 | 32 |

| | h | i | j | k | l | m | n | | o | p |
|---|---|---|---|---|---|---|---|---|---|---|
| Embodiment 1 | — | 14.15 | — | — | — | 120° C. | 30 | Min. | 60 | aluminum laminate |
| Embodiment 2 | — | 9.66 | — | — | — | 110° C. | 20 | Min. | 140 | aluminum laminate |
| Embodiment 3 | — | 1.53 | — | — | — | 100° C. | 20 | Min. | 77 | aluminum laminate |
| Embodiment 4 | — | 1.43 | — | — | — | 90° C. | 15 | Min. | 123 | aluminum laminate |
| Embodiment 5 | — | 2.20 | — | — | — | 85° C. | 10 | Min. | 80 | aluminum laminate |
| Embodiment 6 | — | 3.75 | — | — | — | 85° C. | 10 | Min. | 120 | aluminum laminate |
| Embodiment 7 | — | 1.08 | — | — | — | 79° C. | 9 | Min. | 80 | aluminum laminate |
| Embodiment 12 | — | 0.48 | — | — | — | 80° C. | 3 | Min. | 120 | aluminum laminate |
| Embodiment 13 | — | 0.72 | — | — | — | 80° C. | 3 | Min. | 120 | aluminum laminate |
| Embodiment 8 | — | 3.24 | — | — | — | 80° C. | 10 | Min. | 120 | aluminum laminate |
| Embodiment 9 | — | 1.92 | — | — | — | 80° C. | 5 | Min. | 120 | aluminum laminate |
| Embodiment 10 | — | 0.48 | — | — | — | 80° C. | 3 | Min. | 120 | aluminum laminate |
| Embodiment 11 | — | 0.36 | — | — | — | 80° C. | 3 | Min. | 120 | aluminum laminate |
| Embodiment 14 | 1 | 0.38 | — | — | — | 80° C. | 3 | Min. | 120 | aluminum laminate |
| Embodiment 15 | 1 | 0.32 | — | — | — | 80° C. | 3 | Min. | 120 | aluminum laminate |
| Embodiment 16 | 2 | 0.24 | — | — | — | 80° C. | 3 | Min. | 120 | aluminum laminate |
| Embodiment 17 | 5 | 0.25 | — | — | — | 80° C. | 3 | Min. | 120 | aluminum laminate |
| Embodiment 18 | 5 | 0.34 | — | — | — | 80° C. | 3 | Min. | 120 | aluminum laminate |
| Embodiment 19 | 4 | 0.19 | — | — | — | 80° C. | 3 | Min. | 120 | aluminum laminate |
| Embodiment 20 | 4 | 0.13 | — | — | — | 80° C. | 3 | Min. | 120 | aluminum laminate |
| Embodiment 21 | 4 | 0.18 | — | — | — | 80° C. | 3 | Min. | 120 | aluminum laminate |
| Embodiment 22 | 4 | 0.13 | — | — | — | 80° C. | 3 | Min. | 120 | aluminum laminate |
| Embodiment 23 | 4 | 0.16 | — | — | — | 80° C. | 3 | Min. | 120 | aluminum laminate |
| Embodiment 24 | 5 | 0.16 | — | — | — | 80° C. | 3 | Min. | 120 | aluminum laminate |
| Embodiment 25 | 4 | 0.14 | — | — | — | 80° C. | 3 | Min. | 120 | aluminum laminate |

TABLE 1-2

| | a | b | c | d | e | f | g | h | i | j |
|---|---|---|---|---|---|---|---|---|---|---|
| Embodiment 26 | polyurethane | 20 | FIG. 13 | — | — | — | — | — | — | silicon rubber |
| Embodiment 27 | polyurethane | 20 | FIG. 12 | — | — | — | — | — | — | ethylenepropylene |
| | | | | | | | | | | rubber |
| Embodiment 28 | polyurethane | 20 | FIG. 17 | — | — | — | — | — | — | styrenepropylene |
| | | | | | | | | | | rubber |
| Embodiment 29 | polyurethane | 20 | FIG. 16 | — | — | — | — | — | — | polybutadiene |
| | | | | | | | | | | rubber |
| Embodiment 30 | polyurethane | 20 | FIG. 19 | — | — | — | — | — | — | isoprene rubber |
| Embodiment 31 | polyurethane | 20 | FIG. 18 | — | — | — | — | — | — | polyisobytylene |
| | | | | | | | | | | rubber |
| Embodiment 32 | polyurethane | 20 | FIG. 15 | — | — | — | — | — | — | fluorine rubber |
| Embodiment 33 | polyurethane | 20 | FIG. 23 | — | — | — | — | — | — | silicon rubber |
| Embodiment 34 | polyurethane | 20 | FIG. 14 | — | — | — | — | — | — | silicon rubber |
| Embodiment 35 | | 20 | FIG. 23 | — | — | — | — | — | — | silicon rubber |
| Embodiment 36 | polyurethane | 20 | FIG. 23 | alumina fiber | 50 | — | — | — | 0.036 | silicon rubber |
| Embodiment 37 | polyurethane | 20 | FIG. 23 | silica fiber | 50 | — | — | — | 0.036 | silicon rubber |
| Embodiment 38 | polyurethane | 20 | FIG. 24 | carbon fiber | 50 | — | — | — | 0.036 | silicon rubber |
| Embodiment 39 | polyurethane | 20 | FIG. 20 | glass fiber | 50 | — | — | — | 0.036 | silicon rubber |
| Embodiment 40 | polyurethane | 20 | FIG. 20 | acetate resin | 50 | — | — | — | 0.036 | silicon rubber |
| | | | | fiber | | | | | | |
| Embodiment 41 | polyurethane | 20 | FIG. 20 | polyester | 50 | — | — | — | 0.036 | silicon rubber |
| | | | | resin fiber | | | | | | |
| Embodiment 42 | polyurethane | 20 | FIG. 20 | polyester | 50 | — | — | — | 0.036 | silicon rubber |
| | | | | resin fiber | | | | | | |
| Comparative | silicon | — | spacer without | — | — | — | — | — | — | — |
| example 1 | | | opening | | | | | | | |
| Comparative | epoxy | — | spacer without | — | — | — | — | — | — | — |
| example 2 | | | opening | | | | | | | |
| Comparative | thermoplastic | — | spacer without | — | — | — | — | — | — | — |
| example 3 | polycarbonate | | opening | | | | | | | |
| Comparative | thermoplastic | — | spacer without | — | — | — | — | — | — | — |
| example 4 | polypropylene | | opening | | | | | | | |

| | k | l | m | n | | o | p |
|---|---|---|---|---|---|---|---|
| Embodiment 26 | 1.03 | 1 | 80° C. | 3 | Min. | 120 | aluminum laminate |
| Embodiment 27 | 1.06 | 1 | 80° C. | 3 | Min. | 120 | aluminum laminate |
| Embodiment 28 | 3.30 | 1 | 80° C. | 3 | Min. | 120 | aluminum laminate |
| Embodiment 29 | 1.14 | 1 | 80° C. | 3 | Min. | 120 | aluminum laminate |
| Embodiment 30 | 3.00 | 2 | 80° C. | 3 | Min. | 120 | aluminum laminate |
| Embodiment 31 | 1.11 | 3 | 80° C. | 3 | Min. | 120 | aluminum laminate |
| Embodiment 32 | 1.26 | 4 | 80° C. | 3 | Min. | 120 | aluminum laminate |
| Embodiment 33 | 1.26 | 5 | 80° C. | 3 | Min. | 120 | aluminum laminate |
| Embodiment 34 | 1.30 | 1.1 | 80° C. | 3 | Min. | 85 | aluminum laminate |
| Embodiment 35 | 1.73 | 3 | | 4 | Min. | 86 | aluminum laminate |
| Embodiment 36 | 0.86 | 1.2 | 80° C. | 3 | Min. | 90 | aluminum laminate |
| Embodiment 37 | 0.43 | 1.2 | 80° C. | 3 | Min. | 100 | two layers of |
| | | | | | | | polyethylene film + |
| | | | | | | | PET film |
| Embodiment 38 | 0.43 | 1.2 | 80° C. | 3 | Min. | 100 | two layers of |
| | | | | | | | polyethylene film + |
| | | | | | | | PET film |
| Embodiment 39 | 0.43 | 1.2 | 80° C. | 3 | Min. | 100 | two layers of |
| | | | | | | | polyethylene film + |
| | | | | | | | PET film |
| Embodiment 40 | 0.43 | 1.2 | 80° C. | 3 | Min. | 105 | film with mainly |
| | | | | | | | clay mineral |
| Embodiment 41 | 0.43 | 1.2 | 80° C. | 3 | Min. | 110 | single layer of |
| | | | | | | | vacuum-deposited |
| | | | | | | | polypropylene film |
| Embodiment 42 | 0.43 | 1.2 | 80° C. | 3 | Min. | 110 | single layer of |
| | | | | | | | vacuum-deposited |
| | | | | | | | polypropylene film |
| Comparative | — | — | 120° C. | 20 | Min. | −20 | aluminum can |
| example 1 | | | | | | | |
| Comparative | — | — | placed at | 1 | day | 155 | aluminum laminate |
| example 2 | | | room | | | | |
| | | | temperature | | | | |
| Comparative | — | — | extrusion of | 20 | seconds | 120 | aluminum laminate |
| example 3 | | | molten resin | | | | |
| | | | at 200° C. | | | | |
| Comparative | — | — | extrusion of | 30 | seconds | 50 | aluminum laminate |
| example 4 | | | molten resin | | | | |
| | | | at 200° C. | | | | |

TABLE 1-3

| | q | r | s | t | u | v |
|---|---|---|---|---|---|---|
| Embodiment 1 | 500 | 86 | 126 | 79 | 80 | 8 |
| Embodiment 2 | 500 | 82 | 118 | 78 | 80 | 8 |
| Embodiment 3 | 500 | 7 | 110 | 77 | 80 | 8 |
| Embodiment 4 | 500 | 76 | 108 | 77 | 80 | 8 |
| Embodiment 5 | 500 | 60 | 85 | 77 | 80 | 8 |
| Embodiment 6 | 500 | 58 | 82 | 77 | 80 | 8 |
| Embodiment 7 | 500 | 56 | 85 | 77 | 80 | 8 |
| Embodiment 12 | 520 | 48 | 66 | 74 | 81 | 7 |
| Embodiment 13 | 520 | 44 | 64 | 72 | 81 | 7 |
| Embodiment 8 | 520 | 41 | 78 | 71 | 81 | 7 |
| Embodiment 9 | 520 | 36 | 74 | 70 | 82 | 7 |
| Embodiment 10 | 520 | 24 | 71 | 69 | 82 | 7 |
| Embodiment 11 | 520 | 22 | 68 | 69 | 82 | 4 |
| Embodiment 14 | 520 | 19 | 54 | 69 | 83 | 3 |
| Embodiment 15 | 520 | 16 | 48 | 69 | 83 | 2 |
| Embodiment 16 | 520 | 14 | 44 | 69 | 83 | 2 |
| Embodiment 17 | 520 | 12 | 37 | 69 | 83 | 1 |
| Embodiment 18 | 520 | 10 | 28 | 69 | 83 | 0 |
| Embodiment 19 | 520 | 8 | 16 | 69 | 83 | 0 |
| Embodiment 20 | 520 | 7 | 12 | 65 | 83 | 0 |
| Embodiment 21 | 520 | 6 | 10 | 64 | 83 | 0 |
| Embodiment 22 | 520 | 5 | 8 | 63 | 84 | 0 |
| Embodiment 23 | 520 | 3 | 6 | 61 | 84 | 0 |
| Embodiment 24 | 520 | 3 | 3 | 61 | 84 | 0 |
| Embodiment 25 | 520 | 3 | 3 | 59 | 84 | 0 |

TABLE 1-4

| | q | r | s | t | u | v |
|---|---|---|---|---|---|---|
| Embodiment 26 | 520 | 3 | 3 | 59 | 84 | 0 |
| Embodiment 27 | 520 | 2 | 2 | 59 | 84 | 0 |
| Embodiment 28 | 520 | 2 | 1 | 59 | 84 | 0 |
| Embodiment 29 | 520 | 2 | 1 | 59 | 84 | 0 |
| Embodiment 30 | 520 | 2 | 1 | 59 | 84 | 0 |
| Embodiment 31 | 520 | 1 | 1 | 59 | 84 | 0 |
| Embodiment 32 | 520 | 1 | 1 | 59 | 84 | 0 |
| Embodiment 33 | 535 | 1 | 1 | 59 | 84 | 0 |
| Embodiment 34 | 535 | 1 | 1 | 59 | 84 | 0 |
| Embodiment 35 | 536 | 1 | 1 | 56 | 86 | 0 |
| Embodiment 36 | 550 | 0 | 0 | 54 | 87 | 0 |
| Embodiment 37 | 560 | 0 | 0 | 52 | 87 | 0 |
| Embodiment 38 | 560 | 0 | 0 | 51 | 87 | 0 |
| Embodiment 39 | 560 | 0 | 0 | 50 | 88 | 0 |
| Embodiment 40 | 570 | 0 | 0 | 48 | 90 | 0 |
| Embodiment 41 | 580 | 0 | 0 | 47 | 90 | 0 |
| Embodiment 42 | 580 | 0 | 0 | 46 | 91 | 0 |
| Comparative | 500 | 251 | 211 | 96 | 61 | 10 |
| example 1 | | | | | | |
| Comparative | 500 | 220 | 208 | 97 | 1 | 10 |
| example 2 | | | | | | |
| Comparative | 420 | 301 | 651 | 93 | 0 | 10 |
| example 3 | | | | | | |
| Comparative | 420 | 315 | 628 | 91 | 0 | 10 |
| example 4 | | | | | | |

In Table 1-1 and Table 1-2, items a to h are described below.

a: reaction-curable resin
b: dimension-absorbing ability (%)
c: shape
d: spacer material
e: deflection temperature under load of spacer (° C.)
f: parameter of degree of solubility of reaction-curable resin perpolymer σ(MPa)^{1/2}
g: parameter of degree of solubility of spacer σ (MPa)^{1/2}
h: difference of SP value
i: total area of spacers (cm²)

In Table 1-1 and Table 1-2, items j to p are described below.

j: mold protrusion having dimension-absorbing ability
k: mold contact area (=total opening area)/battery contact area
l: total opening area of surface/total opening area of rear surface
m: hardening type
n: hardening time
o: glass transition pin of reaction-curable resin (Tg) (° C.)
p: battery package

In Table 1-3 and Table 1-4, items q to v are described below.

q: rated energy density of power supply (Wh/l)
r: number of bad coatings (per 1000 pieces) of reaction-curable resin
s: number of bad bubble biting (per 1000 pieces) of reaction-curable resin
t: highest temperature of surface of battery pack in 2C discharging with PCT protection circuit disabled (° C.)
u: capacity maintenance ratio after 500 cycles in charging 1C/discharging 1C cycle test
v: reference test: number of packs (per 10 pieces) with temporary power failure in falling test of device mount 1 m

Embodiment 1 to Embodiment 25 described in Table 1-1 are embodiments of a power pack having the spacers 12. The detail of the embodiments is described in Table 1-1. As can be seen from Table 1-3, for example, embodiments 19 to 25 have an excellent effect of considerably reducing the number of bad reaction-curable resin.

The embodiments 26 to 35 described in Table 1-2 are examples of a battery pack formed by a convex portion for positioning which has dimension-absorbing ability, and having positioning marks (openings). The embodiments 36 to 42 described in Table 1-2 are embodiments of a battery pack having both spacers and positioning marks (openings). The detail of the embodiments is described in Table 1-1. As can be seen from Table 1-4, the embodiments have excellent effects.

The comparative examples 1 to 4 described in Table 1-2 are battery pack without a spacer and an opening. As shown in Table 1-4, in the comparative examples, the properties of a battery pack are deteriorated as compared with the embodiments, such that there are many defects.

### Embodiment 43 to Embodiment 46, Comparative Example 6 to Comparative Example 8

Table 2 relates to an example, as shown in FIG. 21, in which a portion 47 of the mold corresponding to the position of the seal 46 is cooled and formed and whitening is prevented by reducing the crosslink density of only the resin 48 on the in-molded internal seal 46.

TABLE 2

| | a | b | c | d | e^{′} | f′ | m | n | | o |
|---|---|---|---|---|---|---|---|---|---|---|
| Embodiment 43 | polyester-based | 20 | FIG. 21 | glass | hologram, | 100 | 80° C. | 3 | Min. | 120 |
| | polyurethane | | | fiber | thermal paper | | | | | |
| Embodiment 44 | polyester-based | 20 | FIG. 21 | glass | water | 170 | 80° C. | 3 | Min. | 120 |
| | polyurethane | | | fiber | detection | | | | | |
| | | | | | seal, RF-ID | | | | | |
| Embodiment 45 | polyester-based | 20 | FIG. 21 | glass | hologram | 100 | 80° C. | 3 | Min. | 120 |
| | polyurethane | | | fiber | functioning as | | | | | |
| | | | | | thermal paper | | | | | |
| Embodiment 46 | polyester-based | 20 | FIG. 21 | glass | hologram | 100 | 80° C. | 3 | Min. | 120 |
| | polyurethane | | | fiber | functioning as | | (partially | | | |
| | | | | | thermal paper | | 30° C.) | | | |
| Comparative | polyester-based | — | spacer | — | hologram, | 100 | room | 1 | day | 40 |
| Example 6 | polyurethane | | without | | thermal paper | | temperature | | | |
| | | | hole | | | | | | | |
| Comparative | thermoplastic | — | spacer | — | water | 170 | extrusion of | 20 | seconds | 120 |
| Example 7 | polycarbonate | | without | | detection | | molten resin | | | |
| | | | hole | | seal, RF-ID | | at 200° C. | | | |
| Comparative | thermoplastic | — | spacer | — | hologram, | 100 | extrusion of | 30 | seconds | 50 |
| Example 8 | polycarbonate | | without | | thermal paper | | molten resin | | | |
| | | | hole | | | | at 220° C. | | | |

| | p | q | r | s | t | u | v | w | x | y |
|---|---|---|---|---|---|---|---|---|---|---|
| Embodiment 43 | aluminum | 520 | 2 | 2 | 55 | 86 | 0 | — | 50 | |
| | laminate | | | | | | | | | |
| Embodiment 44 | aluminum | 500 | 2 | 2 | 54 | 86 | 0 | 10 | 50 | |
| | laminate | | | | | | | | | |
| Embodiment 45 | aluminum | 520 | 1 | 1 | 53 | 87 | 0 | 10 | 50 | |
| | laminate | | | | | | | | | |
| Embodiment 46 | aluminum | 520 | 1 | 1 | 50 | 87 | 0 | 10 | 90 | visibility of |
| | laminate | | | | | | | | | information |
| | | | | | | | | | | body |
| | | | | | | | | | | improved |
| Comparative | aluminum | 350 | 223 | 210 | 96 | 0 | 10 | 0 | 30 | |
| Example 6 | laminate | | | | | | | | | |
| Comparative | aluminum | 380 | 319 | 643 | 92 | 0 | 10 | 0 | 30 | RF-ID |
| Example 7 | laminate | | | | | | | | | disabled |
| Comparative | aluminum | 420 | 315 | 628 | 91 | 0 | 10 | 0 | 30 | hologram |
| Example 8 | laminate | | | | | | | | | uncolored |

In Table 2, the items are described below. a to d and m to v are the same as the items in Table 1-1, Table 1-2, Table 1-3, and Table 1-4.

a: reaction-curable resin
b; dimension-absorbing ability (%)
c: shape
d: spacer material
e′: film for anticounterfeit, water detection, or authentication
f′: uncolored temperature of hologram/heat-resistant temperature of RF-ID
m: hardening type
n: hardening time
o: glass transition pin of reaction-curable resin (Tg) (° C.)
p: battery package
q: rated energy density of power supply (Wh/l)
r: number of bad coatings (per 1000 pieces) of reaction-curable resin
s: number of bad bubble biting (per 1000 pieces) of reaction-curable resin
t: highest temperature of surface of battery pack in 2C discharging with PCT protection circuit disabled (° C.)
u: capacity maintenance ratio after 500 cycles in charging 1C/discharging 1C cycle test
v: reference test: number of packs (per 10 pieces) with temporary power failure in falling test of device mount 1 m
w: reference test: number of operations (per 10 pieces) of RF-ID in falling test of device mount 1 m
x: transmittance of resin on seal
y: remarks

As shown in Table 2, Embodiments 43 to 46 has the advantage in that not only the number of defects is small due to excellent properties as a battery pack, but the transmittance of the resin on the seal, as compared with Comparative examples 6, 7, and 8.

### Embodiments 33, 34, 45 to 50, and 53 to 58 and Comparative Examples 9 and 10

Table 3-1 and Table 3-2 show embodiments and comparative examples of battery packs having the frame-shaped formed portion having openings at the top described above. Table is divided into two parts (Table 3-1 and Table 3-2) because there are many items to describe. Table 3-2 is continued under Table 3-1.

TABLE 3-1

| | A | B | C | D | E | F | G |
|---|---|---|---|---|---|---|---|
| Embodiment 33 | phenol novolak-based | FIG. 28D | FIG. 26A | OK | FIG. 31A | adhesive | no |
| | epoxy resin, | | | | | | |
| | methyltetrahydrophthalic | | | | | | |
| | anhydride | | | | | | |
| Embodiment 34 | hydrogenated bisphenol A- | FIG. 25 | FIG. 26A | OK | FIG. 31A | double- | no |
| | based epoxy resin, | | | | | sided tape | |
| | dodecenylsuccinic | | | | | | |
| | anhydride | | | | | | |
| Embodiment 45 | bisphenol F-based epoxy | FIG. 24 | FIG. 26B | OK | FIG. 31B | double- | contact side portion with metal |
| | resin, | | | | | sided tape | portion of other module |
| | methaphenylenediamine | | | | | | |
| Embodiment 46 | bisphenol F-based epoxy | FIG. 27A | FIG. 26B | OK | FIG. 31B | double- | contact side portion with metal |
| | resin, show amine1010 | | | | | sided tape | portion of other module |
| Embodiment 47 | epochlorohydrine fusion of | FIG. 27B | FIG. 26B | OK | FIG. 31C | double- | contact side portion with metal |
| | bisphenol A, WONDAMINE | | | | | sided tape | portion of other module |
| | HM | | | | | | |
| Embodiment 48 | epochlorohydrine fusion of | FIG. 27C | FIG. 26B | OK | FIG. 31C | double- | contact side portion with metal |
| | bisphenol A, Araldit HY-964 | | | | | sided tape | portion of other module |
| Embodiment 49 | epochlorohydrine fusion of | FIG. 27D | FIG. 26B | OK | FIG. 31C | double- | contact side portion with metal |
| | bisphenol A, | | | | | sided tape | portion of other module |
| | ethylenetriamine | | | | | | |
| Embodiment 50 | epochlorohydrine fusion of | FIG. 28A | FIG. 26B | OK | FIG. 31C | double- | contact side portion with metal |
| | bisphenol A, | | | | | sided tape | portion of other module |
| | dimethylaminopropylamine | | | | | | |

| | H | I | J | K | L | M | N | O | P |
|---|---|---|---|---|---|---|---|---|---|
| Embodiment 33 | 80° C. | 3 Min. | 120 | aluminum | 545 | 15 | 78 | OK | 8 |
| | | | | laminate | | | | | |
| Embodiment 34 | 80° C. | 3 Min. | 85 | aluminum | 550 | 13 | 74 | OK | 7 |
| | | | | laminate | | | | | |
| Embodiment 45 | 80° C. | 3 Min. | 120 | aluminum | 555 | 11 | 70 | OK | 5 |
| | | | | laminate | | | | | |
| Embodiment 46 | 80° C. | 3 Min. | 120 | aluminum | 560 | 9 | 67 | OK | 4 |
| | | | | laminate | | | | | |
| Embodiment 47 | 80° C. | 3 Min. | 120 | aluminum | 565 | 8 | 65 | OK | 3 |
| | | | | laminate | | | | | |
| Embodiment 48 | 80° C. | 3 Min. | 120 | aluminum | 570 | 7 | 63 | OK | 2 |
| | | | | laminate | | | | | |
| Embodiment 49 | 80° C. | 3 Min. | 120 | aluminum | 575 | 6 | 61 | OK | 1 |
| | | | | laminate | | | | | |
| Embodiment 50 | 80° C. | 3 Min. | 120 | aluminum | 580 | 5 | 59 | OK | 0 |
| | | | | laminate | | | | | |

TABLE 3-2

| | A | B | C | D | E | F | G |
|---|---|---|---|---|---|---|---|
| Embodiment 53 | epochlorohydrine | FIG. 28B | FIG. 26B | OK | FIG. 31C | double-sided | contact side portion with metal |
| | fusion of bisphenol | | | | | tape | portion of other module |
| | A, AMINE 248 | | | | | | |
| Embodiment 54 | polyether-based | FIG. 28C | FIG. 26B | OK | FIG. 31D | double-sided | contact heat pipe to top |
| | polyurethane | | | | | tape | exposed portion |
| Embodiment 55 | polyether-based | FIG. 29 | FIG. 26B | OK | FIG. 31D | slide fitting | contact metal portion of other |
| | polyurethane | | | | | portion to side | module and heat pipe to |
| | | | | | | portion | bottom and top exposed |
| | | | | | | | portion |
| Embodiment 56 | polyether-based | FIG. 30A | FIG. 26B | OK | FIG. 31D | slide fitting | contact metal portion of other |
| | polyurethane | | | | | portion to top | module and heat pipe to |
| | | | | | | and bottom, | bottom and top exposed |
| | | | | | | putting bottom | portion |
| | | | | | | with levered | |
| | | | | | | tool principle | |
| | | | | | | by putting top | |
| Embodiment 57 | polyether-based | FIG. 30B | FIG. 26B | OK | FIG. 31D | fitting portion | contact metal portion of other |
| | polyurethane | | | | | to top, thread- | module and heat pipe to |
| | | | | | | fastening | bottom and top exposed |
| | | | | | | portion to | portion |
| | | | | | | bottom | |
| Embodiment 58 | polyether-based | FIG. 30C | FIG. 26B | OK | FIG. 31D | fitting portion | contact metal portion of other |
| | polyurethane | | | | | to top, thread- | module and heat pipe to |
| | | | | | | fastening | bottom and top exposed |
| | | | | | | portion to | portion |
| | | | | | | bottom | |
| Comparative | non-reactive resin: | FIG. 23 | FIG. 26D | OK | | adhesive | |
| Example 9 | polyamide | | | | | | |
| Comparative | non-reactive resin: | FIG. 14 | FIG. 26D | OK | | double-sided | |
| Example 10 | thermoplastic | | | | | tape | |
| | polypropylene | | | | | | |

| | H | I | | J | K | L | M | N | O | P |
|---|---|---|---|---|---|---|---|---|---|---|
| Embodiment 53 | 80° C. | 3 | Min. | 120 | aluminum | 585 | 4 | 56 | OK | 0 |
| | | | | | laminate | | | | | |
| Embodiment 54 | 70° C. | 4 | Min. | 110 | aluminum | 590 | 3 | 52 | OK | 0 |
| | | | | | laminate | | | | | |
| Embodiment 55 | 70° C. | 3 | Min. | 110 | aluminum | 595 | 2 | 44 | OK | 0 |
| | | | | | laminate | | | | | |
| Embodiment 56 | 70° C. | 4 | Min. | 110 | aluminum | 600 | 1 | 41 | OK | 0 |
| | | | | | laminate | | | | | |
| Embodiment 57 | 70° C. | 4 | Min. | 110 | aluminum | 605 | 0 | 37 | OK | 0 |
| | | | | | laminate | | | | | |
| Embodiment 58 | 70° C. | 4 | Min. | 110 | aluminum | 630 | 0 | 34 | OK | 0 |
| | | | | | laminate | | | | | |
| Comparative | room | 1 | day | 40 | aluminum | 380 | 102 | 96 | NG | 10 |
| Example 9 | temperature | | | | laminate | | | | | |
| Comparative | extrusion of | 30 | seconds | 50 | aluminum | 450 | 113 | 91 | NG | 10 |
| Example 10 | molten resin | | | | laminate | | | | | |
| | at 220° C. | | | | | | | | | |

In Table 3-1 and Table 3-2, items A to K are described below.

A: reaction-curable resin (corresponding to the item a in Table 1 and Table 2)
AB: shape (corresponding to the item c in Table 1 and Table 2)
C: seal portion of film package
D: whether to coating seal portion with film package
E: electric connecting portion shape
F: fixing type of battery pack
G: whether contact with cooling mechanism such as another module metal portion and heat pipe of battery pack
H: hardening type (corresponding to the item m in Table 1 and Table 2)
I: hardening time (corresponding to the item n in Table 1 and Table 2)
J: glass transition pin (Tg) (° C.) of reaction-curable resin (corresponding to the item o in Table 1 and Table 2)
K: battery package (corresponding to the item p in Table 1 and Table 2)

In Table 3-1 and Table 3-2, items L to P are described below.

L: rated energy density of power supply (Wh/l) (corresponding to the item q in Table 1 and Table 2),

M: number of bad bubble biting (per 1000 pieces) of reaction-curable resin (corresponding to the item s in Table 1 and Table 2),

N: highest temperature of surface of battery pack in 2C discharging with PCT protection circuit disabled (° C.) (corresponding to the item t in Table 1 and Table 2),

O: test method of discharging of static electricity regulated by IEC/EN 61000-4-2 in which when there is discharging in the battery pack in discharging at 8 kV in the air was NG, and

P: reference test: number of packs (per 10 piece) with a temporary power failure at two times for six surfaces in device mounting 1.2 m falling test.

As can be seen from the items L to P in Table 3, the embodiments has excellent effects as compared with the comparative examples.

The present disclosure contains subject matter related to that disclosed in Japanese Priority Patent Application JP 2010-254277 filed in the Japan Patent Office on Nov. 12, 2010 and Japanese Priority Patent Application JP 2011-008520 filed in the Japan Patent Office on Jan. 19, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A battery pack comprising:
a formed portion coating at least a portion of the outer surface of a battery or a plurality of batteries with reaction-curable resin; and
spacers having dimension-absorbing ability and attached to the rear surface of the formed portion.

2. The battery pack according to claim 1, wherein the battery or the plurality of batteries is implemented by packing a battery element with a film package and the formed portion is formed of reaction-curable resin less than 120° C.

3. The battery pack according to claim 1,
wherein the reaction-curable resin is selected from silicon, epoxy, acryl, and urethane and a glass transition temperature after forming is 60° C. or more and 140° C. or less.

4. The battery pack according to claim 1,
wherein the spacers are formed by overlapping fiberform materials with holes therein and have dimension-absorbing ability.

5. The battery pack according to claim 4,
wherein the fiberform material is any one or more of a silica fiber, a glass fiber, a carbon fiber, an alumina fiber, an acetate resin fiber, and a polyester resin fiber.

6. The battery pack according to claim 4,
wherein the fiberform materials form two or more layer of meshes and have holes therein and the reaction-curable resin is impregnated in the holes.

7. The battery pack according to claim 1,
wherein the spacer is made of a rubbery material that deforms 3% or more by a mold clamping force of the mold to show dimension-absorbing ability.

8. The battery pack according to claim 7,
wherein the rubbery material is an elastomer and made of any one or more of urethane rubber, silicon rubber, acryl rubber, nitryl rubber, ethylene propylene rubber, styrene propylene rubber, isoprene rubber, polybutadiene rubber, and polyisobutylene rubber.

9. The battery pack according to claim 7,
wherein the shape of the spacer made of the rubbery material has a relationship (mold contact surface area>battery contact area) when a contact surface with a battery component of a film package and a contact surface with the mold are compared.

10. The battery pack according to claim 1,
wherein deflection temperature under load of the spacer according to claim 1 is 40° C. or more and 120° C. or less and the material is deformed 3% or more by heat of the mold and has dimension-absorbing ability.

11. The battery pack according to claim 10,
wherein the material deformed by heat is any one or more of urethane, silicon, acryl, and epoxy.

12. The battery pack according to claim 1,
wherein the difference between a parameter of degree of solubility of the spacer and a parameter of degree of solubility of prepolymer of the reaction-curable resin is 5 or less and dimension-absorbing ability is shown by swelling in injection.

13. The battery pack according to claim 12,
wherein the spacer is made of any one or more of polyvinyl acetate, polyvinyl chloride, polybutyl acrylate, nylon6, epoxy, methyl polymethacrylate, poly n-isopropylacrylicamide, nylon66, polyacrylonitrile, polyvinylalcohol, cellulose acetate, and cellulose.

14. A battery pack comprising:
a formed portion in which at least of the sides of a battery or a plurality of batteries are directly formed; and
a protection circuit,
wherein at least the thickest portion of the battery is exposed from the formed portion.

15. The battery pack according to claim 14,
wherein the battery or the plurality of batteries is implemented by packing a battery element with a film package and the formed portion is formed of reaction-curable resin less than 120° C.

16. The battery pack according to claim 14,
wherein the reaction-curable resin is selected from silicon, epoxy, acryl, and urethane and a glass transition temperature after forming is 60° C. or more and 140° C. or less.

17. The battery pack according to claims 14,
wherein a seal portion of a film package that packs the battery element is disposed at a side and the formed portion covers the end surface of the seal portion.

18. The battery pack according to claims 14,
wherein the formed portion has a fitting portion or a connection portion for thread-fastening.

19. The battery pack according to claim 18,
wherein the connecting portion for thread-fastening is formed at a terrace portion of a laminate battery.

20. The battery pack according to claims 14,
wherein a cooling mechanism of a device is in contact with the exposed portion of the battery or the formed portion.

21. A method of manufacturing a batter pack comprising:
positioning a battery or a plurality of batteries in a forming space by using a mold protrusion having dimension-absorbing ability; and
forming a formed portion by filling the forming space with reaction-curable resin less than 120° C.

22. The method of manufacturing a battery pack according to claim 21,
wherein the mold protrusion is made of a rubbery material that deforms 3% or more by a mold clamping force of the mold.

23. The method of manufacturing a battery pack according to claim 22,
wherein the rubbery material is an elastomer and made of any one or more of silicon rubber, ethylene propylene rubber, styrene propylene rubber, isoprene rubber, polybutadiene rubber, polyisobutylene rubber, and fluorine rubber.

24. A mold for manufacturing a battery pack comprising:
a mold protrusion that protrudes from the inner surface of a mold having a forming space accommodating a battery or a plurality of battery packs and filled with reaction-curable resin, has a convex shape being in contact with the surface of the battery, has the area at the inner surface of the mold larger than the area at the contact portion with the surface of the battery, and has a substantially conical shape or a pyramid shape.

25. The battery pack according to claim 1, wherein a label for anticounterfeit, water detection, or authentication is disposed in the forming space and the label is in-molded when forming the battery or the plurality of batteries.

26. The battery pack according to claim 25,
wherein transmittance of the reaction-curable resin is increased by cooling a portion of the mold corresponding to the position of the label.
